(19) United States
(12) Patent Application Publication
(10) Pub. No.: US 2010/0105011 A1
(43) Pub. Date: Apr. 29, 2010

(54) System, Method And Apparatus For Tooth Implant Planning And Tooth Implant Kits

(75) Inventors: Issa George Karkar, Burlingame, CA (US); Huafeng Wen, Redwood City, CA (US); Paul George Karkar, Burlingame, CA (US)

Correspondence Address: SQUIRE, SANDERS & DEMPSEY L.L.P., 1 MARITIME PLAZA, SUITE 300, SAN FRANCISCO, CA, 94111, US

(73) Assignee: InPronto Inc., San Francisco, CA (US)

(21) Appl. No.: 12/392,043

(22) Filed: Feb. 24, 2009

Related U.S. Application Data
(63) Continuation-in-part of application No. 12/260,323, filed on Oct. 29, 2008.

(51) Int. Cl. A61C 8/00; B65D 83/00

(52) U.S. Cl. 433/215; 206/368

(57) ABSTRACT

Systems and methods support dental implant patient scheduling and treatment process relating to packaging one or more dental appliances as a kit which is readily used by dental professional during surgery, by communicating manufacturing progress information with a doctor over a network and performing patient scheduling and treatment when the dental appliances reach a certain manufacturing progress. A network-based service may also provide a doctor with a treatment solution including a surgical kit derived from patient data.

This application claims priority as a Continuation-in-Part of U.S. application Ser. No. 12/260,323 entitled “System, Method and Apparatus for Tooth Implants”, and filed on Oct. 29, 2008, the disclosure of which is hereby incorporated by reference in its entirety for all purposes.

### BACKGROUND OF THE INVENTION

1. Field of the Invention

The present invention relates to restorative dentistry; specifically, dental implants relating to surgical, restorative and prosthetic dentistry.

2. Background of the Invention

Implants are now a standard way to attach a dental prostheses. One fixture may support a single tooth replacement, usually cemented or screwed atop an abutment. An implant supported bridge (also called a bar or frame) is used when several teeth are missing.

FIGS. 1A and 1B show the basic anatomical structure for a tooth, and a comparison between this structure and the structure most commonly used for a non-removable dental implant. Referring to FIG. 1A, the crown of the tooth includes an outer enamel layer. Beneath the enamel layer is the dentine and then pulp layer. The zone between the crown and the root portion of the tooth is known as the Cemento-Enamel-Junction (CEJ). The gingival tissue or gum surrounds the tooth around the CEJ level and the periodontal ligaments attach the cementum of the root to the bone. FIG. 1B shows the components of a typical single tooth implant juxtaposed with elements of a natural tooth. The implant includes the fixture which is integrated with the bone (called an implant screw in FIG. 1B) and the prosthetic components known as an abutment and crown.

The implant process begins with a determination that a prosthesis is needed to replace a tooth that is no longer capable of carrying chewing loads, no longer capable of supporting an artificial crown and is determined to be extracted, or where the tooth is missing completely. The restorative dentist may consult with the oral surgeon, trained general dentist, prosthodontist or periodontist to co-treat a patient. Usually, physical models and/or impressions of the patient's jawbones and teeth are made by the restorative dentist at the surgeon's request, and are used as physical aids to treatment planning. If not supplied, the surgeon makes his own or relies upon advanced computer-assisted tomography or a cone beam CAT scan to arrive at a treatment plan. Unless otherwise stated and as will be understood from the context, a “doctor” according to the discussion can refer to a single doctor or plural doctors including restorative dentists, oral surgeons, trained general dentists, prosthodontists, periodontists, and/or others with specializations in one or more of the fields related to restorative dentistry.

The area in which the fixture is needed is examined by an oral surgeon who determines where in the patient's jaw a fixture can be safely supported by the bone without impinging on vital anatomical areas such as nerve bundles, sinus areas, etc. Conventional dental x-rays are sometimes relied on to learn if the underlying bone structure appears suitable to support implants and to identify the areas where nerves or other vital anatomical structures are located. There must be bone having a sufficient load-carrying capacity, i.e., a bone having sufficient bone density and adequate depth and width to support normal and transverse loads on the implant. If bone volume or density is inadequate, a bone graft procedure must be considered first.

Unaided manual preparation of a jaw for fixtures supporting prosthesis is challenging, because of the difficulty in estimating positions and angles accurately by the naked eye, within a deep hole of small diameter in a patient's mouth with limitations to opening. Even if the work is being done by an experienced dentist or oral surgeon, chances for location, angular or orientation errors are great. For this reasons, drill guides are needed to assist with locating not only the proper drill depth, but entry angle of the drill. Positioning or depth indicators have also been developed to assist with obtaining the appropriate depth and orientation of the hole that will receive the fixture. This part of the process, however, is largely if not wholly controlled by the oral surgeon's determination of how to best hold the fixture in the existing bone, avoiding nerve endings, etc. In other words, the oral surgeon's selection of the type and size of the hole needed, the corresponding fixture screw size, its pitch, diameter, and orientation is not also constrained or a function of the patient's bite or the bite registration, the external loading on the prosthesis for the patient's particular mouth, e.g., the orientation of the adjacent teeth or how they will ultimately function in connection with the adjacent prosthesis, or the nature of the soft tissue surrounding the fixture sight. The oral surgeon drills and places the fixture simply based on the location of bone capable of safely supporting the fixture.

A custom drill guide is now often fabricated to help guide the oral surgeon's drill. Cone Beam technology is used to capture an enhanced view of the upper and lower jaw region of a patient's head. The resulting imagery can show the bone structure and teeth in detail as well as the soft tissues. Using specially designed software that aids in predefining appropriate fixture locations, the Cone Beam data can be used to create another set of data defining the location, orientation, and depth of each cavity to be prepared. From this, with use of a numerically controlled drilling tool, a patient- and case-customized drill guide or surgical guide is constructed. When properly mounted in the patient's mouth, guided holes in this unit align the drilling tool for its use in creating each predefined fixture cavity. Each fixture is then inserted and moved into its permanent predetermined location.

After installation of a fixture screw, the implant planning and installation can vary, depending on how long a delay (of up to six months) is allowed for accommodation of the fixture(s) by the bone of the jaw. Some fixture manufacturers recommend loading fixtures immediately, others do not. If a healing delay is to be observed, a healing abutment or a cover screw—a metal extension washer with a domelike-top—is fastened to each fixture by a screw in the threaded hole of the fixture, and the gum flesh is either sutured over the abutment or allowed to heal and granulate around the protruded abutment above the tissue.

On successful completion of the foregoing fixture procedure, the patient returns to the Dentist for the later process steps. To install the prosthesis, tissue over the fixture is reopened using a knife or a punch. The healing abutment or the cover screw is removed from the fixtures to reveal the surfaces on which the frame's attachment points will rest. Dental impressions are made of upper and lower jaws using transfer metal copings that attach to the fixture level of the implant. Molds (positive models of the jaws) are made from these impressions, in a traditional procedure duplicating the position of the implants, the soft tissue and the natural teeth. The dental impression or physical molds, after being shipped to a dental laboratory, are used to build up a prosthesis in a traditional highly labor-intensive process demanding high accuracy, skill level and long experience for good results.

Thus, traditional prosthesis planning begins after the fixture is installed, not at the beginning, before any surgery has taken place. The traditional process may be likened to that of a house built in an ad-hoc fashion. The ground is excavated and cement poured to create a supporting formwork for a building before deciding what type of building will be supported by the basement, the environmental conditions that the building must withstand, or how the building will sit relative to adjacent architecture. It would be preferred to arrive at a whole design of the integrated prosthesis (fixture, abutment and crown) from the beginning, before any surgery has taken place so that the best implant for the job can be fashioned. In order to do so, the collective sum of the knowledge that goes into each step of creating and installing a prosthesis should be considered.

Other suggestions for implant planning and selection, and related concepts are described in U.S. Pub. No. 2007/0154866, U.S. Pat. No. 7,322,824 and U.S. Pub. No. 2008/0153061.

In view of the above, it will be appreciated that today's typical protocol for preparation of the mouth for, and placement of, dental implants involves the following considerations:

a) The human jawbone is highly variable in thickness and density from location to location, and varies from person to person. Thus, for a given individual's jaw, certain implant locations are preferable to others because of bone strength variations.

b) For implant attachment strength, the optimal direction at which the fixture should pass into the bone varies from one jaw location to another, and bone configurations are different from person to person. If the hole in the bone is drilled at an incorrect location and/or angle, the tip of the fixture may pass through the bone and out the far side, weakening its attachment strength and in some instances compromising the integrity of the entire fixture. Protruding fixture tips also raise patient objections on cosmetic grounds.

c) Poor placement of fixtures can be a source of problems in installing and using a prosthesis. If fixtures exit the jaw unparallel with one another it may be more difficult to align the prosthesis to the fixtures properly. In addition, when fixture axes are far from parallel, biting forces will translate from purely compressive force to bending force more likely to fracture the bone, the fixture itself or the prosthetic screws holding the prosthesis to the fixtures.

The known art for the fixture process usually includes installing a titanium screw, installing an abutment, and then installing a corresponding crown atop the abutment. Safety and aesthetics are usually considered during this process (as noted above), but due to a lack of an available systematic analysis of the overall restorative device functions after implantation, the fixture may not function as intended. This may lead to subsequent return trips to the restorative dentist or surgeon, replacement of crowns or repair of the supporting jaw due to extensive bone loss, infections, etc.

It would be preferred to have answers to questions such as the functional aspect of the final implant restoration from the implant tip representing the root tip of the natural tooth to the cusp tip of the fabricated crown and the final occlusion and how this effects proper placement of the implant, before the implant is placed in the mouth. For example, how much pressure is being placed on the bone-implant interface? Implant loads from chewing and parafunction can exceed the physio biomechanic tolerance of the implant bone interface and/or the titanium material itself, causing failure. This can be a failure of the implant itself (fracture) or bone loss, or a “melting” or resorption of the surrounding bone.

It would be advantageous if the above and other concepts, questions, etc. could be communicated over a closed or private network, or public network, such as the internet. The Internet has become a significant medium for communication and commerce and has enabled millions of people to share information and conduct business electronically. The unique characteristics of the Internet, such as its ability to provide enhanced communication, rich text, and a graphic environment provides an ideal setting for a wide variety of electronic commerce applications.

Additionally, a networked service can assist the consumer, whether patients, doctors or related health professionals, by providing relevant information and enabling consumers to request information at their convenience 24 hours a day, seven days a week. Thus, network, e.g., the Internet, has evolved into a unique sales and marketing channel. The ubiquity and convenience of the Internet makes it ideal for dispensing information on certain topics that traditionally require visits to specialists. Moreover, with today's transmission bandwidth for upload/download features, data intensive services become possible. In this current environment it becomes more realistic to share 3D related data-intensive applications among network nodes using standard network protocols for connectivity.

### SUMMARY OF THE INVENTION

The invention relates to aspects of dental implant planning and selection. The restorative dentist should decide what type of prosthesis will be fabricated. Only then can the specific fixture requirements including number, length, diameter, and thread pitch be determined. In other words, the case should be reverse engineered by the restoring dentist, prior to any surgery.

According to one aspect the invention addresses piece-meal or ad-hoc selection and planning. Unlike current approaches for installing implants, where each step is performed separately, without foreseeing what will be built upon a previous element, the fixture screw is selected and planned without knowing what kind of abutment will be put on, an abutment is selected or custom designed without knowing what kind of crown or bridge is built and put on, etc. In accordance with the foregoing objectives there is a process in which each element's role in the finished product is realized before any layer is put in place. A modeled, reverse engineered dentition based on patient data can provide the missing information.

A systematic approach includes extracting the untreated anatomic model, which includes teeth, root, jaw bones and tissue from patient data. This information is then used to create a treated anatomic model, which includes reverse engineering the missing tooth or teeth, based on the root position and angulation, jaw bones-types and density modeled gingival tissues and adjacent tooth structures if present, all obtained from the patient as a comprehensive set of data. After this information is obtained, answers to such questions as what type of titanium screw is proper, screw positions and orientations, screw depth, the abutment type, emergence profile, how should the tissue be punched and modeled after healing, and how should the crowns and bridges be installed above the abutment attachment, can be more accurately answered.

According to another aspect, a method provides, in a systematic manner, what has in many cases been a product of skill and experience in restorative dentistry. Rather than rely on the collective expertise and cross-specializations of the various specialists involved in implant planning and selection, where each process has many variables, the idealized solution can be presented to everyone involved in the process. This may be referred to as a reverse engineering solution. By analogy, this concept replaces the house building plan where the foundation is built before knowing what is required of the structure that will be supported by the foundation with an integrated house plan in which the foundation and structure supported by the foundation are designed together, starting with the finished product. Hence, in one respect the invention presents a methodology in which the final result of the implant process, based on the natural features of a healthy tooth, are understood for the specific condition being treated, and before any steps have been taken.

A missing tooth model is, in one respect, the integrated final house design that shows what the foundation will support with respect to the house analogy. In a preferred embodiment a software tool is used to construct a missing tooth in a patient mouth model, as if the patient had never lost the tooth. This missing tooth model enables the consulting dentist, restoration specialist, and/or oral surgeon to realize how the final product is intended to function and how it will look. Some aspects of this model include an accurate tissue punch modeling capability, which produces a gum line that reflects the gum line and the emergence profile of a healthy natural tooth. The model may also include the capability of accurately modeling the gingival tissue after the implant has been set, and the corresponding supporting abutment design that will result in an emergence profile for the implant that can be indistinguishable from adjacent, natural teeth.

One aspect of the invention is model-based processes that lead to selection of the implant components, surgical guide and/or related implant protocol or part manufacture that may be delivered to a doctor in an implant kit. According to this aspect of the invention, the methods used to arrive at an implant kit may include the step of “reverse engineering the tooth” or “reverse engineering the missing tooth”. This term is defined as the step of predicting, calculating or modeling the functional and aesthetic aspects of a natural tooth, as if it were not missing from the patient's mouth. Thus, the “reverse engineering the tooth” step includes modifying the patient mouth model to include a natural, missing tooth at the location(s) where the implant is intended. An implant, tissue punch, surgical guide, abutments (healing, temporary and/or final) and crown may then be prescribed, described, defined or manufactured in accordance with the attributes of this missing tooth so that the final implant can possess the most similar functional and aesthetic features as possible to that predicted, calculated or modeled for the missing tooth in the “reverse engineering the tooth” step.

According to another aspect of the invention, a software-based analytic model includes, or is adapted as a design tool for predicting the biomechanical properties of the patient's mouth, including the reverse-engineered missing tooth. For example, the model may be used to perform a rigid body loads analysis, or a more detailed stress/strain analysis using Finite Elements or another theoretical approach for computing coupled, biomechanical loading among anatomic structure. The model may further allow the re-shaping or reconfiguring of a missing tooth and then evaluating whether this would be the configuration of a healthy, natural tooth, as if the patient were not missing the tooth.

Aspects of the invention include preparing models of the reverse engineered tooth, which models will be generally referred to as missing tooth models (MTMs), and related appliance mouth models (AMMs), and then using such models to evaluate alternatives and provide recommendations/comments on a procedure to be followed. It is contemplated that this aspect of the invention can be practiced in at least the following situations. A doctor can collect patient data, such as CT scans and bite registrations, and upload this information to a network-based service provider that provides dental implant solutions. This service provider would then prepare an MTM and AMM and based on the information revealed in these models, e.g., a predicted biomechanical response obtained from a static loads analysis, fabricate an implant kit for delivery to the doctor. In another example, a doctor can prepare a three-dimensional model including a reverse engineered tooth at his/her workstation. In this situation, the doctor may be the restorative dentist. The MTM and/or a draft AMM may then be transmitted to the oral surgeon for consultation on the type of dentition properties needed in the fixture, and whether the patient's supporting jaw can accept the fixture as planned or to request alternatives. In another example, the doctor would send a copy of the AMM and/or MTM, or a portion thereof, e.g., a 3D viewer file, to an appliance manufacturer for specifying instructions/needs in a fixture screw, abutment or crown.

In accordance with the foregoing objectives, it is expected that the teachings of the invention provide a solution to the growing problem of high medical costs. In view of these teachings, there should be an avenue available to significantly reduce medical costs and importantly, to enable a person who needs a restoration to be able to afford it. Medical care providers, e.g., medical insurance companies, should realize that the invention presents a process, system and method that can significantly decrease the uncertainty associated with a restoration, e.g., fewer re-visits, corrections, cost estimates, etc.

According to another aspect of the invention, there is a network-based service for consumers, i.e., patients, doctors and related medical professionals relating to restorative dentistry. For example, some of these consumers may be interested in products and services associated with dental implant and restoration services at a centralized location which brings together all aspects of the process, from the perspective of the patient, referring dentist, restorative dentist, oral surgeon, prosthodontist, etc. According to the known art, the process instead operates as several silo processes that shuffle a patient from one dental practitioner to another. This results in unnecessary processes and increased costs, a reliance on individualized experience, ad-hoc decision making, inappropriate treatment plans, and an inability for the medical practitioner/professional to give an accurate estimate of the cost to the patient before the treatment or the patient being able to make a well informed decision. By assembling all disciplines at a central location, a practitioner can prepare a pre-design treatment unique to the patient, provide more accurate estimates which lead to more informed patient decision making, and better managed delivery and scheduling of appliances. In short, locating all specializations at a networked site can, in light of the disclosure, allow a practitioner, e.g., restorative dentist, to gain a far better appreciation of all considerations/factors bearing upon the optimal solution for the patient and fashion that solution based on his/her intimate knowledge of what the patient needs. Hence a preferred end-to-end solution to what is known today as a complex, inter-disciplinary dental implant restoration process.

In one aspect, there are network-based systems and methods to support dental implant restoration relating to one or more dental appliances by communicating manufacturing process information with a network, delivery of, or advice concerning surgical kits or procedures, performing administrative functions such as patient scheduling and billing when one or more dental appliances reach a predetermined manufacturing stage. The network may provide information both at the doctor-patient level, nurse-patient, and doctor-doctor level. Hereafter this network resource shall be referred to as a restoration dentistry community network (or portal). This service may, in one respect, be constructed to include support for building and maintaining social networks and a virtual community of dental patients, dentists, specialists such as oral surgeons, financial institutions, insurance companies, benefit providers and the providers of dental equipment or services. For treating professionals, such as dentists, the system provides a one-stop solution for planning patient treatments, managing communications and schedules with patients, storing patient records and sharing information with others in the field.

Implementations of the foregoing systems may include one or more of the following. A network server can send a message to a practitioner when the appliances reach a certain manufacturing stage. The message can be sent when the appliances are being tracked by an internal ERP system. The server can send a message to a treating professional when the appliances reach certain stages of manufacturing. The server can send an electronic mail message to transmit information relating to a manufacturing process. The server can maintain calendar pages for the treating professionals. The server can invite a patient to access an on-line timeline and schedule an appointment. A network of treating professionals can be accessed/consulted with over this network.

The appliances needed to fabricate and install an implant may be procured through the network-based service. Upon receiving the patient data with the restoration plan from the doctor, a participating member of the community network, or owner/operator may provide a treatment solution, e.g., a surgical kit or information about the suitable/available appliances, in accordance with the principles of invention, as one service provided to doctors.

In accordance with the foregoing, the networked system may be adapted for quickly reporting to a user, subscriber, client, customer etc. such as a doctor the status of a manufacturing operation for the dental appliances. If a particular manufacturing operation is late or early, the doctor can more easily manage patient visits.

The system may also provide a virtual treatment simulation that a patient and treating doctor can download and view via a secure network portal. This simulation or digital treatment plan can be used to arrive at the appliances best suited for the implant. The information associated with the patient's treatment (visual images, virtual treatment plans, 3D simulation, file notes and the like) are digitized and maintained in a secured central storage facility. Doctors and patients may access these files from a secure file server without a need to extract files and models from a third-party storage site and with reduced risks of records being misplaced, and/or paying intermediate information services for access to such information.

In another aspect, there is a method, system and apparatus for communicating to a dental professional an implant kit and/or implant plan for performing a restoration based on analysis of patient data. In one respect, there is a method for formulating a predictive model based on a re-engineered missing tooth, from which the appliance specifications can be determined and/or appliances may be manufactured for the kit. In another aspect, there is a process for communicating the appliance information in the kit to the doctor, including steps for using appliances based on a decision reached mid-treatment.

As to deciding which appliances are needed, in one aspect the following steps may be undertaken to provide an optimal or near-optimal solution for a patient. First, an initial pre treatment digital model, or pre-treatment mouth model (PTMM) is made based on the patient data. Next, an ideal solution is modeled, as determined from analytic techniques, by constructing a missing tooth model (MTM)—reverse-engineering the missing tooth (or teeth). Next, the reverse-engineered tooth model is used to select the individual components/appliances and steps/processes that will be employed to install the prosthesis such that the predicted properties of the missing tooth are matched as closely as possible. These appliances are modeled in an appliances mouth model (AMM). Once this model is made the appliance specifications can be determined. In one embodiment, a kit includes four parts: (1) practice model, (2) surgical components, (3) provisional prosthetics solution, and (4) final prosthetics solution. The kit may include only a portion of any of the four parts based on a practitioner's needs, e.g., a practitioner may not want a practice model. A practitioner may request that a portion of the kit be delivered and afterwards determine whether the rest of kit is needed based on a mid-treatment outcome. E.g., a practitioner may just want the practice model, surgical components and provisional prosthetics solution. He or she may then wait until mid-treatment outcome before determining whether to accept the formerly designed final prosthetics solution, or request a new set of final prosthetics solution based on mid-treatment outcome after the provisional prosthetics solution is in place.

A delivered kit may be packaged to reduce the complexity associated with the step-by-step process of dental restoration. In connection with the modeling information the network service can fashion treatment steps which are communicated in the kit by color coding, separate packaging, numbering, etc. Additionally, the kit can take into account the possibility that a doctor may need to adjust a treatment plan based on patient response. The network service (or community portal) provides the doctor with an easily accessed resource for ordering appliances that become needed as the treatment progresses. These appliances can be anticipated by the service provider who has worked with the doctor, providing consultation, etc., and constructed the predictive models in connection with formulating a treatment solution.

While it would be preferred to know, a-priori the exact protocol from start to finish for installing a prosthesis, at present it is expected that a doctor may need to use a different course of action depending on the patient response to initial treatment. As to this need, the implant kit may incorporate a decision tree for delivery or communication of the appliances and related information needed during the course of treatment depending on how a patient responds to initial treatment. Thus, for example during surgery should a doctor choose an immediate loading over a delayed loading, the doctor may communicate the decision to take a particular route to the network service, which would then order or procure the necessary appliances, or the doctor may order the needed appliance directly from a manufacturer based on appliance information included in the kit, e.g., dimensions, material, etc. In another embodiment, the doctor may simply choose among different portions of the kit depending on the decision reached during mid-treatment.

According to another aspect of the invention, a patient implant kit includes both a practice model portion and a final portion. Both the practice portion and final portion includes appliances specifically chosen, e.g., milled/sized in view of results predicted from a MTM or AMM for the patient, as opposed to a collection of appliances to try-on the patient. A patient implant kit according to the invention may be a packaged and shipped item that contains practice and final models specifically selected for treating the patient's condition. One advantage of this aspect of the invention is that a doctor need not pre-order and store several different sizes/types of appliances to try-on patients in a typical ad-hoc fashion.

In accordance with one or more of the foregoing principles of invention, the following additional aspects of invention will be appreciated in light of the disclosure.

According to one embodiment, an implant treatment solution includes a kit comprising a network connection, decision tree and appliances custom-built to treat the patient's unique condition. The network connection may include a kit received from, monitored and supported by a network-based service provider. The decision tree can provide a complete, end-to-end and self-contained set of instructions for using the kit. The kit may further include tamper-resistant features. The kit may further include RFID tags or other tag types that can detect when a component is removed from its compartment and activate a warning signal, for example, when the practitioner does something improper. The kit may further include a locking system to ensure that the kit is used properly, especially when one of the multiple mutually exclusive treatment paths is chosen.

According to one embodiment, a method for providing a treatment solution for a doctor includes the steps of receiving patient information, constructing a patient model from the patient information including a model of a missing dentition, selecting the appliances for the prosthetic implant including at least a fixture, crown and abutment, and providing the selected appliances to the doctor. The selecting step may include providing the doctor with a fixture specification for manufacture of a fixture for the prosthetic implant, or manufacturing a fixture which then be shipped to the doctor.

According to another embodiment, a restoration kit for a patient having dentition includes a prosthetic implant adapted for being surgically installed in a patient's mouth to replicate a missing dentition, the implant including a crown, an abutment adapted for supporting the crown, and a fixture adapted for supporting the abutment and a surgical guide adapted for locating a surgical tool in the patient's mouth. The kit may further include a tissue punch adapted for being used with the surgery, a drill guide adapted for being used with the surgical guide, and/or a practice kit and a surgical kit comprising the prosthetic implant and surgical guide. The practice kit may include an artificial arch, artificial gingiva, practice fixture, abutment and crown, and practice surgical guide. The kit may further include indicia communicating an ordered sequence associated with each of the respective crown, abutment, fixture and surgical guide for communicating a process for restoring the patient dentition using the kit.

According to another embodiment, a prosthetic implant kit for restoring a patient's dentition includes a plurality of appliances for installing a prosthetic implant in the patient's mouth, instructions for installing a fixture, a first kit portion adapted for use after the fixture is installed and a first outcome results from the installed fixture, and a second kit portion adapted for use after the fixture is installed and a second outcome results from the installed fixture. The first kit portion may include appliances suited for a delayed loading of the fixture and the second kit portion includes appliances suited for an immediate loading of the fixture. The first and second outcomes may, respectively, correspond to a first maximum torque and a second maximum torque level, respectively, reached by a surgical tool when the fixture was installed. The first kit portion may include a cover screw and the second kit portion includes a pre-engineered custom healing abutment. The kit may include a plurality of indicia, each one of the plurality of indicia being associated with one or more of the respective one of the appliances, wherein an indicia communicates one of an ordered sequence of steps for installing the implant using the corresponding one or more appliances associated with the indicia.

According to another embodiment, a kit may include a means for tracking the kit, or portions of the kit. This may be useful for collecting information on how a kit is used, when appliances are or will be needed, or to trigger instructions on a local video screen. One technology suited for this purposes is RFID tags. In one example, an RFID tag, or a simple switch may be triggered and a RF signal transmitted when a seal is broken or box removed from a package. On an adjacent monitor this signal would trigger a video or demonstration to commence or advance to the relevant section, which would instruct the user on proper use of the appliance or communicate other relevant information. In another example, a first and second tag or switch could be arranged such that, if the corresponding first and second appliance or steps are performed in the correct sequence, the first switch will trigger before the second switch. When each switch is triggered, a corresponding signal may then be sent to a local monitor, or broadcast to a monitoring station. If the second switch is triggered before the first switch, this may therefore be used to activate a warning on a local monitor or at a monitoring station that the procedure is not being conducted properly. An embodiment may also include simple instructions on top of or adjacent to appliance compartments, which show how to activate video instructions, e.g., “load CD then press 3”, for instructing a practitioner on how to use one or more appliances.

According to another embodiment, a kit may include a locking feature. For example, if a particular path is chosen for treatment, which requires appliance set #2 to be used, instead of appliance set #3, then the kit may preclude use of appliance set #3. Such a feature may be adopted as a safety feature to minimize instances of misuse of appliances and ensure that only pre-approved procedures/solutions are followed. According to these embodiments, the lock feature may alternatively serve as a means for generating revenue by selling portions of kits, but without having to force a buyer to pay for an entire kit up front.

For example, a complete patient kit is prepared by a service provider, packaged and shipped to a doctor. The doctor may decide to only pay for the first kit portion on the assumption that a second kit portion may, or may not be needed. After payment is received, the doctor receives the key to “un-lock” the first kit portion. Then, if the doctor finds that the second kit portion is needed, e.g., after the treatment has commenced, he/she may purchase the second kit portion which would require, on the sellers side, simply providing the doctor with the key to unlock the second kit portion. There is no wait time for arrival of the second portion, only the time it takes to pay for the second key.

The tracking, locking, safety and purchase on-demand embodiments of the implant kit just described may be separate or included together as one kit, or the kit may be programmable to provide one or more of these features. In one embodiment a kit includes circuitry for this purpose. The components of a locking and/or tracking system may be built into, or integral with, the package, wrapper, or box where the compartments for appliances are located. The locking system may include a microcontroller that monitors a plurality of switches located adjacent each respective compartment holding an appliance. These switches may be mechanical switches or optical switches. The microcontroller may have a transmitter that transmits wireless signals over a local network for purposes of notifying whether an appliance is being misused, a set of appliances wishes to be purchased, or to initiate online instructions in response to selection of an appliance.

According to another aspect of the invention, there is a means for providing a plurality of appliances in a sequence corresponding to one or more protocol for installing the implant. The means may include providing a plurality of components arranged in discrete compartments according to the one or more protocol for installing the implant, a first indicia associated with one or more first appliances and a second indicia associated with one or more second appliances, wherein the one or more appliances associated with the first indicia are used before the one or more appliances associated with the second indicia. The first indicia may be a first color, number, letter or symbol.

The means for providing may include a first set of one or more appliances, a second set of one or more appliances, and a third set of one or more appliances, the first set of one or more appliances being used before the second and third sets of one or more appliances, and means for providing the second set of appliances if, after using the first set, a first outcome occurred, and for providing the third set of appliances if the first outcome does not result. The means for providing may include a network site for selecting the second set or third set, depending on whether the first outcome occurred, or separately packaged second and third kits containing the respective second and third sets of one or more appliances.

According to another embodiment, a method for selecting a dental implant includes the steps of providing a predictive model of the dental implant based on a patient-specific mouth model, the mouth model being adapted for representing the anatomical structure for supporting the implant and the loading on a body representing the dental implant; predicting the loading profile for a model of a natural tooth located at the dental implant intended position; and based on the predicted loading, selecting an implant suitable for reproducing the loading profile.

According to another aspect of the invention, a method for drill guide design includes the steps of providing bone scan data and surface scan data, producing a mouth model including a tooth and jawbone model where the tooth crown models are taken from the surface scan data and the jawbone model and tooth root models are derived from the bone scan data, and then designing the drill guide based on the crown surfaces in the model in relation to the modeled root and jawbone. In one embodiment the model is created by superimposing the surface scan data acquired from the polyvinyl impressions of the patient's mouth with the bone scan data acquired from the cone beam CT scan of the patient's head.

According to other embodiments of the invention, a dental implant, or portion thereof produced by the one or more of the foregoing methods are provided.

According to other embodiments of the invention, a patient mouth model stored on computer readable medium includes a model of the patient's supporting jaw structure, the patient's dentition, and a model of a tooth missing from the patient's mouth. The tooth model includes a crown and root.

According to other embodiments of the invention, a patient mouth model stored on computer readable medium includes a model of the patient's gingival layer, jawbone and dentition. The model may further include a model of missing tooth adapted for use as a guide for planning and selection of an implant at the missing tooth location.

A systematic approach to implant planning and selection in accordance with the foregoing principles of invention may include computer simulation software based on CAT scan data that allows virtual implant surgical placement based on a barium impregnated prototype of the final prosthesis. This predicts vital anatomy, bone quality, implant characteristics, the need for bone or soft tissue grafting, and maximizing the implant bone surface area for the treatment case creating a high level of predictability. Computer CAD/CAM milled, selective laser sintering, stereo lithography, or other rapid prototyping method based drill guides can be developed for the surgeon to facilitate proper fixture placement based on the final prosthesis occlusion and aesthetics. Treatment planning software can also be used to demonstrate “try-ins” to the patient and practitioners on a computer screen. Digital data from a CAT scan (such as an iCAT or a NewTom) can provide accurate simulations that are easily understood by patients and practitioners. When options have been fully discussed between patient and surgeon/restorative dentist, software adapted to practice the methods of the invention can be used to produce precision drill guides and other restorative components.

In accordance with the foregoing objectives, it will be appreciated that aspects of the invention offer benefits to doctors and related health professionals, as well as to the patient. The invention can eliminate the need for significant capital investments, reduce administrative time and coordination, reduce trial and temporary dentures, and reduce the probability of poor outcomes, yielding more profit and less hassle. As for patients, in comparison to existing implant practices, there is less elapsed time, fewer office visits, longer implant durability, better esthetics, less pain, significantly reduced post operative complications, and an appreciable reduction in the overall costs associated with an implant.

### INCORPORATION BY REFERENCE

All publications, patent applications or patents mentioned in this specification are herein incorporated by reference to the same extent as if each individual publication or patent application was specifically and individually indicated to be incorporated by reference.

### BRIEF DESCRIPTION OF THE DRAWINGS

The invention, together with further advantages thereof, may best be understood by reference to the following description taken in conjunction with the accompanying drawings in which:

FIGS. 1A and 1B show the basic elements of a natural tooth and an implant.

FIGS. 2A-2B are flow diagrams depicting a planning and selection method according to one or more examples set forth in the disclosure. The flow diagrams may be regarded as an implant planning and selection method that includes three phases. The first phase is the construction of the mouth model, pre-implant, which is referred to as the pre-treatment mouth model or PTMM. The second phase is the construction of a mouth model post-implant. The post-implant model includes a missing tooth model, or MTM, i.e., the natural tooth, located where the implant is planned. From this representation the attributes of the implant are determined, i.e., abutment, crown and fixture, which is part three of the process. The process for arriving at the missing tooth model and, in essence the features for the implant may, although not necessarily be iterative as indicated in FIGS. 2A-2B. The model of the patient's mouth with the installed appliances or appliance mouth model (AMM) is the final model. The processes depicted in FIGS. 2A-2B may be carried out on a personal computer, a cell phone, or workstation. The iterative steps depicted may include additional parameters, other than load vector comparisons, as will be understood from the disclosure.

FIG. 2C shows a pair of flow diagrams. The left hand diagram describes the typical steps involved in a conventional approach to implant planning and selection, as will be appreciated. The right hand side shows the steps involved according to aspects of the disclosure. It is possible to arrive at both a significant reduction in the number of steps for, and a simplification to the implant planning and selection process, in addition to the other advantages, as indicated in FIG. 2C The benefits to both doctors and patients will be apparent.

FIG. 2D depicts a community network and information services associated with one aspect of the invention.

FIG. 3A shows a bone scan for an anterior tooth. FIG. 3B shows a surface scan for the anterior tooth of FIG. 3A. FIG. 3C shows a bone scan for a posterior tooth. FIG. 3D shows a surface scan for the posterior tooth of FIG. 3C.

FIG. 4A shows a correlation of scan data where crowns of the same anterior tooth in the scan data is used to correlate the anterior tooth scans from FIGS. 3A and 3B, respectively. FIG. 4B shows the resulting bone, tooth and tissue model derived from a superimposing of the surface scan and bone scan data of FIGS. 3A and 3B.

FIG. 4C shows a correlation of scan data where crowns of the same posterior tooth in the scan data are used to correlate the posterior tooth scans from FIGS. 3C and 3D, respectively. FIG. 4D shows the resulting bone, tooth and tissue model derived from a superimposing of the surface scan with the bone scan data of FIGS. 3C and 3D. This may be accomplished by registering, aligning or overlaying the two sets of data.

FIGS. 5A and 5B show side and top views of a tissue portion for the anterior tooth model.

FIGS. 6A and 6B show side and top views of a tissue portion for the posterior tooth model.

FIGS. 7A-7B depict a missing anterior tooth placement process.

FIGS. 8A and 8B show top and perspective views of a control box used to form a missing tooth for a mouth model.

FIGS. 9A and 9B depict dragger nodes for adjusting contours of the missing tooth. The draggers are shown for crown cusps (FIG. 9A), root tip and root furcation portions (FIG. 9B) of a posterior tooth.

FIG. 10A is a diagram depicting the interaction between the missing tooth, an adjacent tooth and an opposing abutting tooth, as represented in a mouth model. FIG. 10B illustrates a free body diagram for the missing tooth model of FIG. 10A. FIGS. 10C and 10D illustrate a resultant force calculation for the missing tooth of FIG. 10A.

FIG. 11A depicts a partial side view of a missing tooth model juxtaposed with the equivalent implant model and illustrated portions of an abutment portion of the missing tooth model. FIG. 11B is a top cross sectional view of the missing tooth model of FIG. 11A illustrating the control points and layers for the abutment portion of the missing tooth model.

FIG. 12 shows components of an implant kit according to the invention. In one embodiment this kit is packaged and delivered to a doctor via a network-based service provider. The doctor will first upload patient data to a secure site. The service then assembles predictive models of the patient's mouth, e.g., an MTM and AMM, from which conclusions are reached as to the type of appliances needed for the implant. The delivered implant kit includes both a practice kit and final kit for surgery.

FIG. 13 shows a decision tree for a restorative treatment. This diagram is both intended to show a typical group of decisions made during the course of treatment, as well as to illustrate a particular embodiment of the invention: a kit package design.

FIGS. 14A-14D depict components of practice models, final models, surgical components, provisional prosthetics, and final prosthetics according to one aspect of the disclosure.

### DETAILED DESCRIPTION OF THE INVENTION

The description proceeds as follows. First, processes for constructing an analytic model for a patient's mouth, e.g., upper and lower arches, occlusion, based on patient data, are discussed. Next, methods for reconstructing a missing tooth are included as part of the patient mouth model. The missing tooth model, intended to replicate how a natural, healthy tooth would sit in the mouth and function, forms the basis for planning and selection of the implant. The process for restoration of the dentition is then explained, which is based on the information obtained from analysis of the missing tooth model.

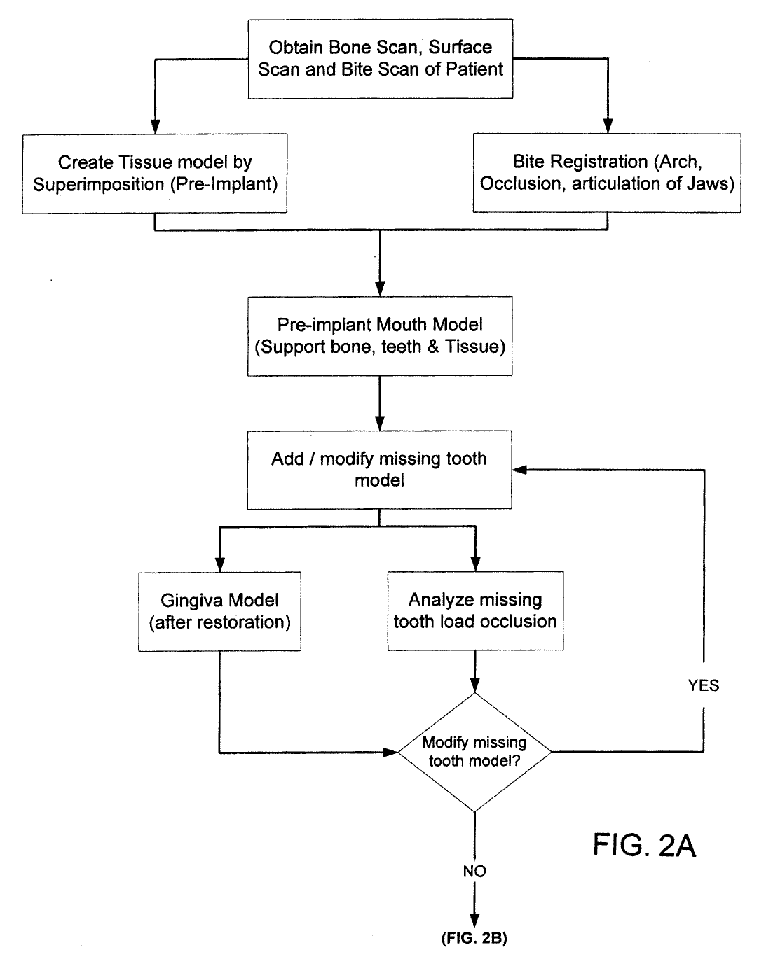

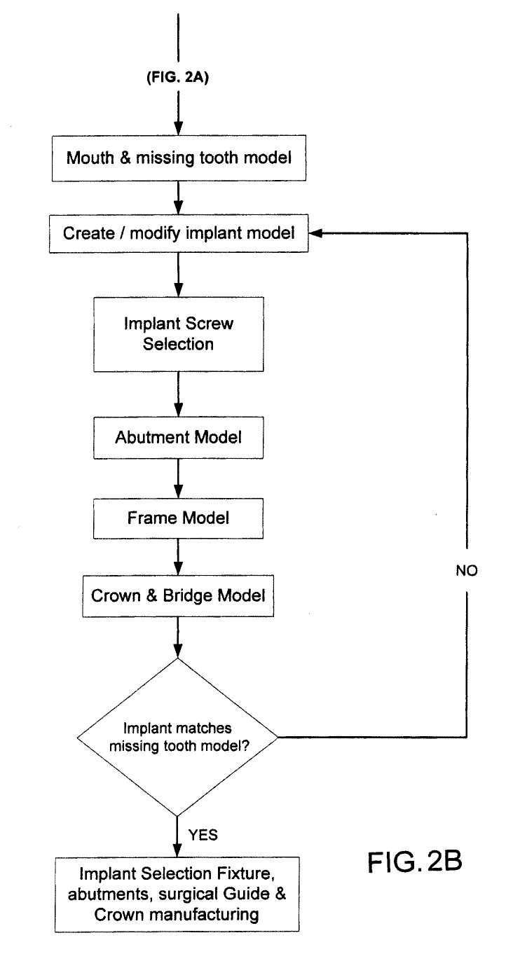

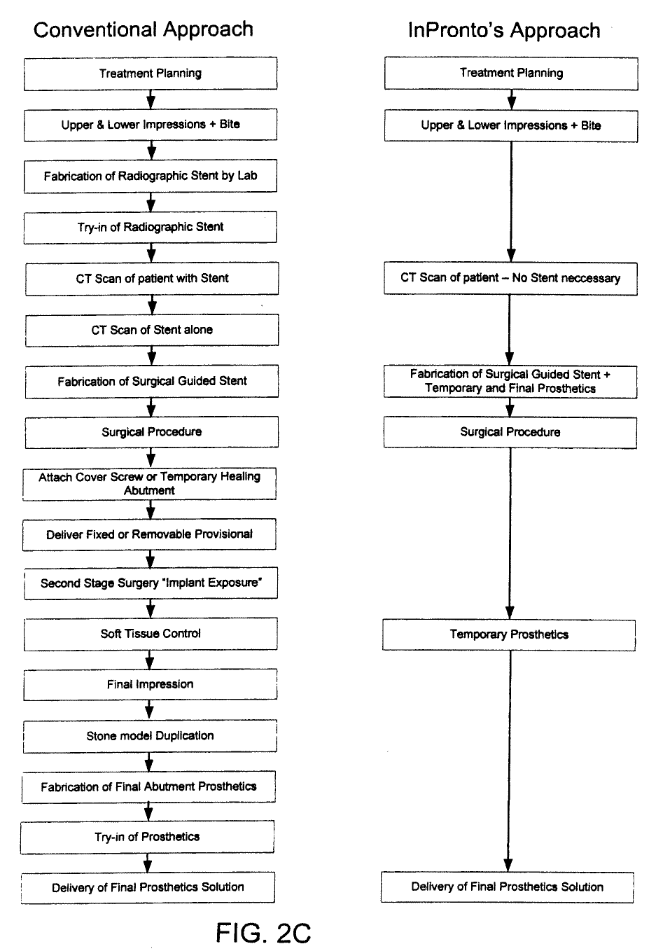

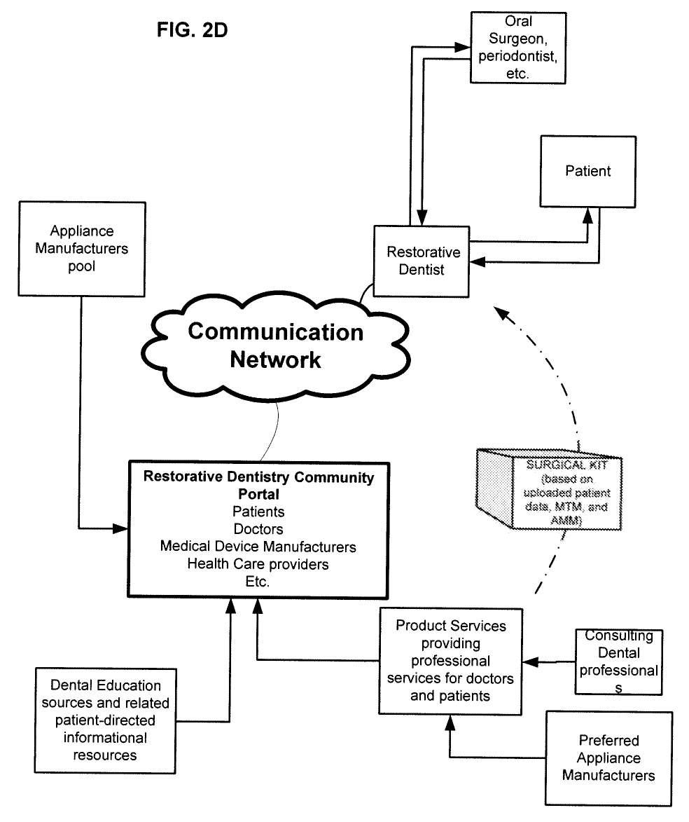

In a preferred embodiment, this process is incorporated into a network-based service that provides a surgical kit for a doctor, such as a restorative dentist (FIG. 2D). In other embodiments the foregoing process may be practiced in part, or in whole on a work station or personal computer operated by a dental professional, e.g., a treating dentist, or a dentist and assistant health professionals. The tools for modeling attributes of a patient's mouth, modeling missing teeth, selecting crown features, abutments, designing a tissue punch, etc. (as discussed below) may be incorporated into a stand-alone software suite which includes a graphical user interface, or GUI. Or these features maybe provided remotely at network-based an application server. One example of a GUI and network-based information system that may be modified to practice methods of the invention is the software tool provided by Simplant software. See http://www.materialise.com/materialise/view/en/129846-Discover+the+latest+version.html (downloaded on Oct. 20, 2008).

Many of the examples described below make reference to a planning and section system, process and/or apparatus for restoring a missing tooth. It should be understood, however, that the principles set forth in the following examples, and in accordance with the foregoing objectives, also apply to planning and section of an implant supported restorative bridge. Thus, the disclosure is not intended to be limited to restoring only a single tooth. The disclosure is, however, to apply only to restorative dentistry of the implant type, not patient-removable tooth borne prosthetics.

Referring to FIG. 2D, a network-based restorative dentistry community portal 100 is accessible over a network, e.g., the internet. The network service may be operated by a consultant/service provider 102 providing restorative dentistry-related services or advice to doctors and their patients. The service provider 102 may be a contributor to a network service devoted to restorative dentistry, or the primary owner/operable of both the network service and the source for professional services, as discussed below. Members of the community having access to, or contributing to the network services include implant manufacturers and consulting doctors/specialists in the field. The site may also have links for patient education, tutorials and related patient care information.

The service provider 102 employees may include staff trained in restorative dentistry and having the necessary skills to accurately model a patient's condition based on uploaded patient data alone, or with the assistance of trained specialists in the field. The service may offer treatment solutions to a requesting doctor, such as the type of appliances needed and the treatment protocol based on analysis of the patient data. The service provider's specialists may make recommendations on the appropriate implant needed, and/or offer comments on a treatment plan. The service may also tap into a network of outside or contracting professionals in the field, e.g., contributing doctors, selected to analyze patient data (as needed) and offer suggestions for a treatment solution based on a particular patient's condition.

The community portal 100 may include accounts for subscribing doctors, as well as their patients. A subscribing doctor may, for instance, be provided a virtual server account for his/her staff and patients to access information, receive, store and upload patient files/records, make schedules and check on the progress of the patient's treatment or appliance manufacturing progress, etc. The server may be set up to have varying levels of access rights, e.g., one for the doctor and his/her staff and another level for patients. Patient accounts may be set-up directly through the service or through the doctor's staff. The service may include accounts for participating appliance manufacturers, which manufacture appliances provide appliances (or provide quotes on appliances) on demand at the network site upon receipt of the appliance model, and accounts for contributing/consulting doctors to submit recommendations. These manufacturers can be resources directly affiliated with the service provider 102 or members of a pool of suppliers that are registered within the network community, in which case the manufacturer's credentials and related information are readily accessible at the network site.

The portal may include file servers for uploading patient information, downloading model data, etc., and exchanging data among health professionals. Application servers at the portal may be used to inspect online patient models including tools for annotation of such models, inserting or pasting comments, e.g., via e-mail or a known messaging system, and providing comments. A patient scheduling server may be utilized by doctor and staff, for purposes of scheduling patient visits, ordering appliances, etc.

As described in greater detail, below, a treatment solution begins with modeling the patient's mouth based on patient data. Patient mouth models may include a pre-treatment model, a reverse-engineered missing tooth model and mouth model with installed appliances, which is based on analysis of the missing tooth model, as described in greater detail, below. As noted above, these models may be provided for download through a file server, or accessed directly for inspection/manipulation at an application server over the network. For example, the service provider 102 may provide, in response to a doctor's treatment plan, a model of the patient's mouth with the installed prosthesis for download or viewing directly at the server with the information needed to order the appliances from an appliance manufacturer. With a reverse-engineered missing tooth model, for example, a doctor may be presented with a variety of optional treatment solutions that will most closely mimic a predicted behavior of the reverse-engineered missing tooth. Alternatively, the models constructed from the service may be sent directly to an appliance manufacturer for making the appliance according to the proscribed treatment plan, or to provide an estimate of the costs associated with manufacturing the implant appliances. The appliance model may be sent to the doctor for presenting a proposed or preliminary solution. The doctor may then choose the best solution for the patient and the patient, annotate or comment on the model, which can then be sent off to the appliance manufacturer.

The community portal 100 can provide for consumers with information on products and services (both patients and doctors) associated with dental implant and restoration services at a centralized location, which brings together all aspects of the process, from the perspective of the patient, referring dentist, restorative dentist, oral surgeon, prosthodontist, etc. By assembling all disciplines at a central location, a doctor/staff can fashion a pre-design treatment unique to the patient, provide more accurate estimates which leads to more informed patient decision making, and deliver all components from one location. In short, locating all specializations at a networked site can, in light of the disclosure, allow a doctor to gain a far better appreciation of all considerations/factors bearing upon the optimal solution for the patient and fashion that solution based on his/her intimate knowledge of what the patient needs.

Examples of the doctor-patient experience according to embodiments of a network-based community portal 100 include sending a message to a practitioner when the appliances reach a predetermined manufacturing stage. The message can be sent when appliances are being tagged, i.e., when they are about to be shipped. The server can send an e-mail or other form of message to the doctor's virtual server when the appliances reach one or more intermediate stages of manufacturing. The doctor's server can maintain calendar pages for the treatment schedule. The server can invite a patient to access an on-line timeline and schedule an appointment when the appliances reach the final stage of manufacturing. The network of treating professionals can be invited/requested to comment on a particular condition from the doctor's server.

Referring to FIG. 2C, there is shown a comparison of the treatment steps involved in a conventional approach for restoration (left side) and the treatment steps or plan according to an alternative approach incorporating aspects of the disclosure (right side). As can be seen from this diagram, there is a far simplified solution provided when aspects of the disclosure are practiced. The conventional approach (left hand side of FIG. 2C) will be discussed first, followed by the alternative approach.

Conventional Approach for Implant Restoration

After the doctor determines that a patient is a good candidate for an implant a full set of upper and lower polyvinyl impressions and a bite impression with a silicone based material is made. These impressions are sent to a laboratory in order to do a diagnostic wax up of the missing teeth in occlusion or set up prefabricated denture teeth that will represent the missing teeth. A radiographic stent is then made.

The stent may be made using suck-down plastic or sprinkle on resin. The acrylic or resin covers the lingual surface of the teeth and half of the buccal surface of the teeth. Verification windows are cut in the stent in order to facilitate a try-in process in the patient's mouth. Undercuts are removed or blocked before this process is done. The acrylic or resin should not cover the occlusal surface of the missing teeth that are planned to be replaced with implants. Radiographic markers are placed on the buccal and lingual flanges of the stent at various heights of the occlusal plane. The stent is polished and sent to the doctor. The doctor places the fabricated stent in the patient's mouth to ensure proper fit, seating and stability. No wobbling is allowed otherwise the stent must be fabricated again. The doctor uses the verification window cuts in the acrylic in order to evaluate the seating of the stent. The patient wears the radiographic stent and bites down on it with, or without a bite registration. A technician then scans the patient with the stent in the mouth. The stent is then removed and scanned separately. The technician sends the patient scans as DICOM files to the dentist.

Commercially-available software, e.g. Nobel guide™, may be used to render the patient's jaw in 3D using the information in the DICOM files. This software, which has a library of implants, can then be used to place a virtual implant in the mouth model for purposes of selection and planning for placement of the implant. The software can also be used to design and render in 3D a surgical guide. These designed parts may then be submitted to Nobel Biocare™ for production.

On the day of surgery the doctor tries the surgical guide in the patient's mouth. He uses anchor pins to anchor the stent in place and prepares the osteotomy with drills and drill inserts. The implant fixture, e.g., screw, is then placed in the jaw bone according to the virtual placement plan.

In a two-stage procedure the doctor attaches a cover screw to the implant and sutures the patient's gum tissue. The doctor waits three to six months before exposing the implant and placing the healing abutment. And then wait another month for tissue healing. After this period, a final abutment is placed and then a temporary crown. The patient then returns to the prosthodontist or GP to have the final prosthetics attached. In the case of a single stage or depending on the case selection there are instances where a surgeon can place a healing abutment directly, or a temporary abutment with a temporary crown or a final abutment and a temporary crown out of occlusion depending on the quality of the bone.

In the more conventional approach, once the cover screw is placed and sutured over, the surgeon proceeds to place a provisional flipper or fixed temporary tooth or teeth bonded to the adjacent teeth. Three to six months later, depending on the healing of the mouth, the patient goes back to the surgeon for the second stage of surgery. Using a laser or tissue punches, the implant fixture is exposed and the cover screw is removed. The temporary healing abutment is then placed and the patient is sutured for a second time.

A month or so later, after the tissue heals for a second time, the final impressions are made at the fixture level, which serves as the basis for design/fabrication of the prosthetics. Stone models and a soft tissue model work are used to model the position of the implanted fixture in the patient's mouth. The final abutments are selected or in some instances, custom abutments are designed and fabricated. If a single unit is designed the final coping and crown is fabricated. If a bridge is designed the framework is fabricated and the porcelain crown(s) are stacked on the bridge, or a single crown is cemented directly onto the frame.

The dentist will then try-in the abutments, framework or the entire bridgework. If modifications are deemed necessary, a new bite scan is taken and then the scan and appliances are sent back to the lab for adjustments. For the patient's final trip to the doctor the final prosthetics are installed in the patient mouth.

As will be further appreciated by the above description, the conventional (or typical) process for implant planning and selection involves fabrication of a portion of the implant after the implant has been installed in the patient's mouth, multiple trips by the patient to different specialists for obtaining patient data, testing appliances, etc.

Alternative Approach for Implant Restoration.

According to the alternative approach (FIG. 2C, right hand side) there is a great simplification to the overall process. In a preferred embodiment, the steps are shared by the doctor and a network-based service provider 102, respectively. In other embodiments, the contribution by the service provider may instead be handled by the doctor. In any case, the benefits of the alternative approach include fewer doctor visits for the patient, more accurate and informed selection of the implant appliances for the patient and reduced costs.

After the doctor has determined that the patient is a good candidate for an implant, a full set of upper and lower polyvinyl impressions and a bite registration with a silicone based material are made. A CT scan is then performed, but without the need for labs nor the fabrication or use of a radiographic stent prior to a CT scan. As will be apparent from the disclosure, a methodology according to the disclosure provides for fabrication of an accurate PTMM based on scanned-based patient data but without requiring a radiographic stent.

The doctor then sends the patient's impressions and CT scan data to the service provider 102 by uploading DICOM files over the network. Alternatively, this information may be directly uploaded from the radiologist. The doctor or radiologist may utilize a virtual server under the doctor's account at the community network, or a separate file server where the files are tagged, stored or labeled as being for the patient model.

The service provider may then conduct a virtual treatment of the patient's condition, e.g., fabricating a PTMM, followed by a MTM and then AMM as discussed in greater detail below. The service provider may then send this model information to a preferred, registered or bidding appliance manufacturer, or the appliance manufacture component of the service provider to produce the appliances needed for the implant. During the course of this development, i.e., model build, verification and then part ordering and manufacture, the doctor may be sent notifications at predetermined stages in the process (as noted above) in order to plan patient visits and/or to notify patients of the progress.

An implant kit may then be packaged to include practice model, final models, surgical components, provisional or final appliances, and sent to the doctor. The implant kit may include labeling with precise directions/instructions for use. The kit includes a practice model specific for the doctor's case and the patient (unlike the conventional approach), in addition to the kit for surgery. The doctor may therefore practice the entire surgery on a practice model that includes aspects of the patient's unique condition, before seeing the patient.

As alluded to earlier, the first step in providing a treatment solution is to collect patient information and doctor's treatment plan (i.e., a specification of the desired, or at least contemplated prosthetic implant the patient needs) and, using this information, construct the patient mouth model. This will now be discussed in more detail.

As discussed above, the flow diagram of FIGS. 2A and 2B depict steps according to a process for planning, design and fabrication of an implant. A digital model of the patient's mouth is first constructed. From this model the desired fixture, abutment and crown are selected. This mouth model is constructed using a combination of medical imaging of both the supporting bone structure in the jaw, a surface scan of the patient's mouth, including the tissue and crowns above the gum line, the bite pattern and bite registration between the upper and lower arches in centric relation. From this data a detailed analytic or mathematical model of the bone, teeth and soft tissue may be developed. This model is then used to represent not only the anatomical structure of bone, sinus cavity, vital nerves and soft gingival tissue, but also the structural aspects of the patient's mouth, as a function of the patient's chewing pattern, arch formation and dimensions, loading of individual teeth, tooth spacing, bone density and the like. The model is also used to formulate a desired gingival tissue shape, volume and topography after the implant is inserted into the jaw bone, using a modeling tool of the gingival tissue. FIG. 2A depicts steps involved with making a mouth model and a missing tooth model. FIG. 2B depicts steps involved in making an implant model intended to mimic the predicted functional and aesthetic features form the missing tooth model. In other embodiments one or neither of the processes depicted in FIGS. 2A-2B are iterative.

Information about the patient's bone structure may be obtained using any suitable scanning technology that can produce images of the supporting bone structure beneath the mouth tissue. For example, the images may be obtained using Cone-Beam Computed Tomography (CBCT) based scanning technology known in the art. See e.g., Scarfe et al., Clinical Applications of Cone-Beam Computed Tomography in Dental Practice, JCDA, Vol. 72, No. 1 (February 2006). The scanned image data may then be communicated to the dentist using the well known Digital Imaging and Communications in Medicine (DICOM) standard for transfer of medical imaging data. DICOM files can provide detailed, three-dimensional representations of the patient's dentition and supporting jaw bone. Information on the DICOM standard may be found at http://www.sph.sc.edu/comd/rorden/dicom.html (downloaded on Oct. 20, 2008). The DICOM file(s) may be made available over a network. For example, the file(s) may be forwarded to a processing center, preferably over a secure data link. The compressed files may then be remotely accessed and processed securely, e.g. via virtual private network, then forwarded from a server center to the dentist.

A Bone Scan is a scan generated by Cone Beam CT machines such as i-CAT®, iluma®, NewTom®, Galileos, Scanora, ProMax3D, PreXion, etc. This scan may give volumetric data, and usually comes out in a DICOM format. The scan can give information about the jawbone, teeth, nerve and sinus. The data produced by this bone scan will be called “bone scan data”, which refers to a three-dimensional representation of anatomic structure produced from, e.g., a series of consecutive two-dimensional image slices having a gray-scale representation of different anatomic structure. The bone scan data provides information on the patient's existing crown formations relative to the jawbone, the location of tooth roots, the bone and ligament structure supporting the teeth, and the location of other soft tissue such as nerve endings. These images can inform one of the depth and variation in bone density that can support, or is available for supporting an implant, as well as the adjacent areas of the mouth that are to be avoided, such as nerve endings and/or weak or less dense bone structure.

A Surface Scan is a scan intended to map or trace the surface contours of the patient's dentition. The data, called “surface scan data”, is usually stored in polygonal format, e.g. STL or PLY. Surface scan data may be obtained in different ways:

By using an Intra Oral Scan, which scans the dentition intra orally, e.g. 3M Brontes Scanner, Cadent iTereo, Orametrix SureSmile;

By an Impression Scan, where a scan of the dental impressions is made directly. Then the surface scan data is obtained from the impression using an industrial CT scanner, like Flash CT from Hytec; or

By a Dental Plaster Scan, where the impression is poured into dental plasters, the dental plasters are then scanned using mainly laser, white light, or mechanical probes. E.g. 3Shape and Nobel Biocare™ piccolo/forte.

The surface scan data details the surface contours of the mouth and are also used to construct the mouth model. A surface scan can provide a highly accurate depiction of the gingival tissue, as well as the clinical crown shape, contour and morphology of the teeth above the gum line.

Information on the patient's bite is also obtained for the mouth model. A bite impression may be obtained from an intra-oral scanner, or an industrial 3D CT scanner. Alternatively, a positive dental plaster of the opposing articulated arches may be scanned using a laser, whitelight, infrared or mechanical scanner in order to obtain a bite impression. This bite scan data can be used to obtain most of bite surface information, usually in polygonal format. From this bite scan, a bite registration between the upper and lower arches for the mouth model is constructed representing the centric relation between the two arches and depicting the maximum interdigitation points of contact between these opposing cusps of the Maxillary and Mandibular teeth. From this information, the relative movement of the upper and lower arches during occlusion and function may be determined.

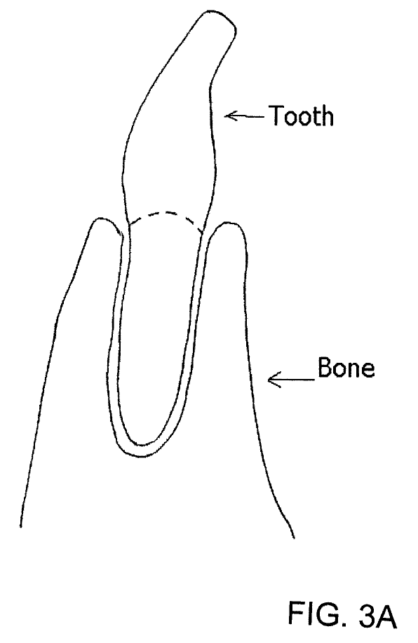

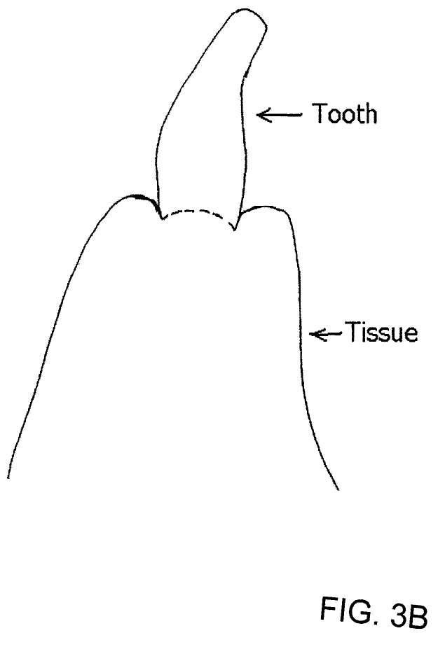

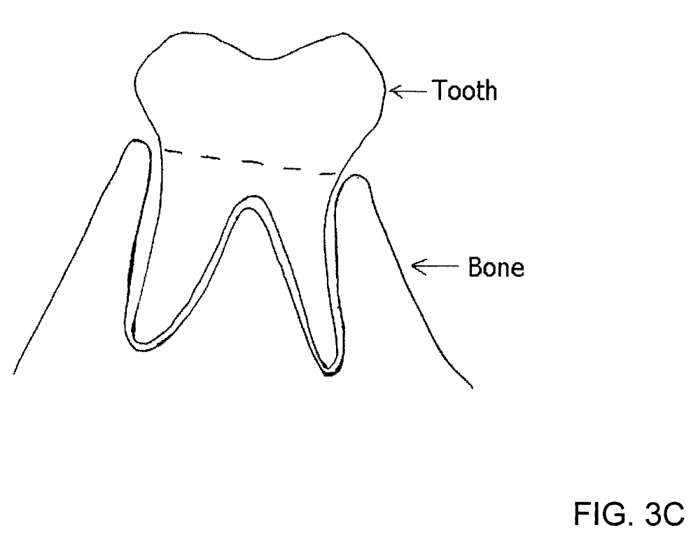

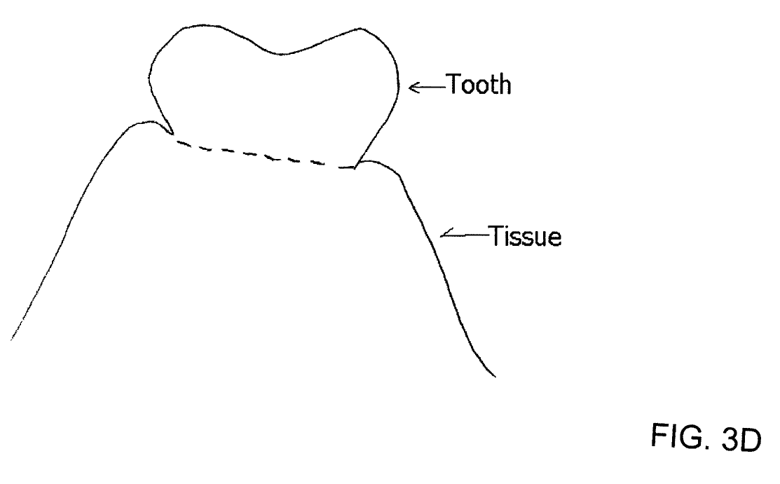

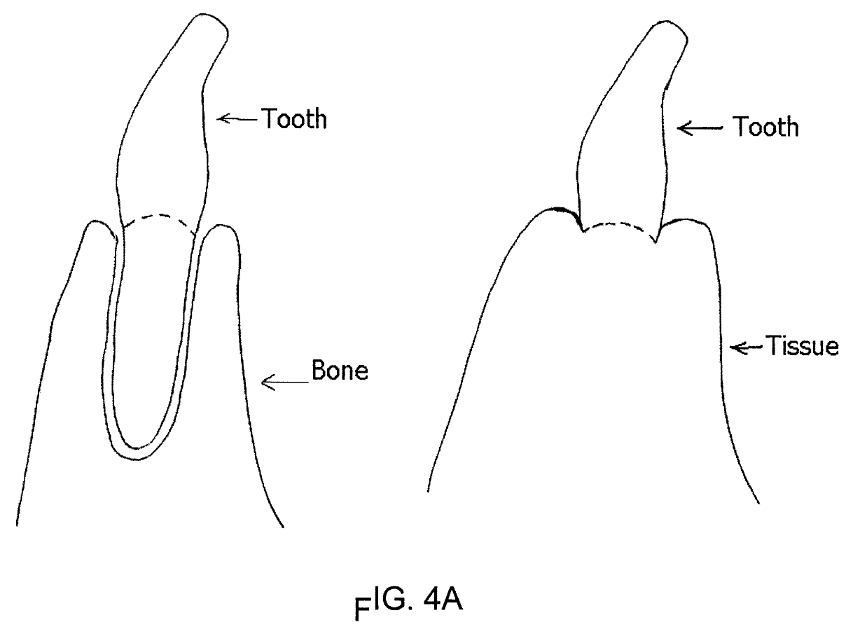

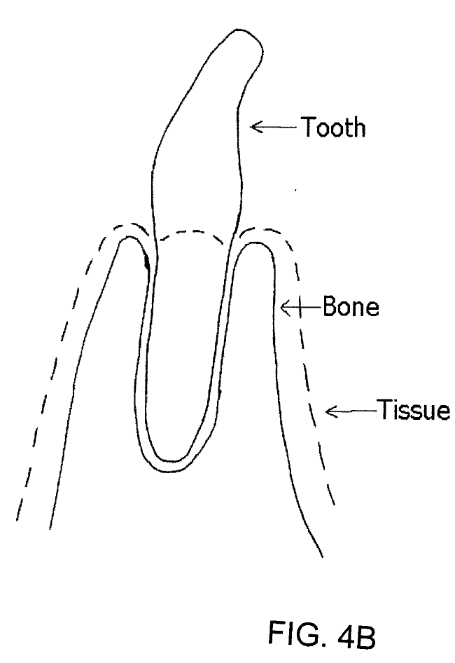

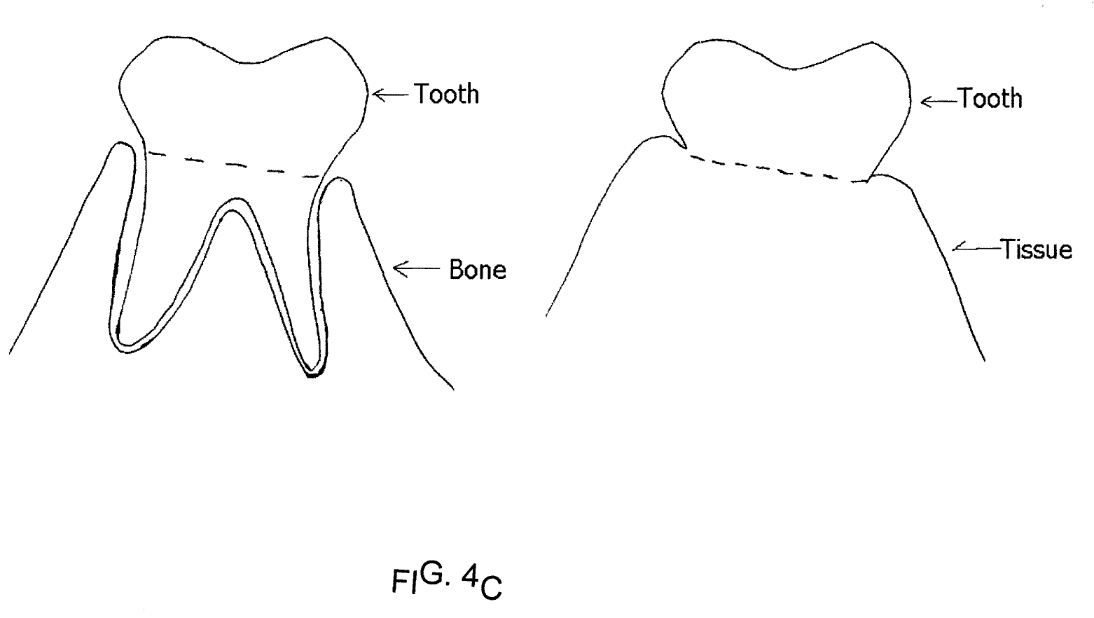

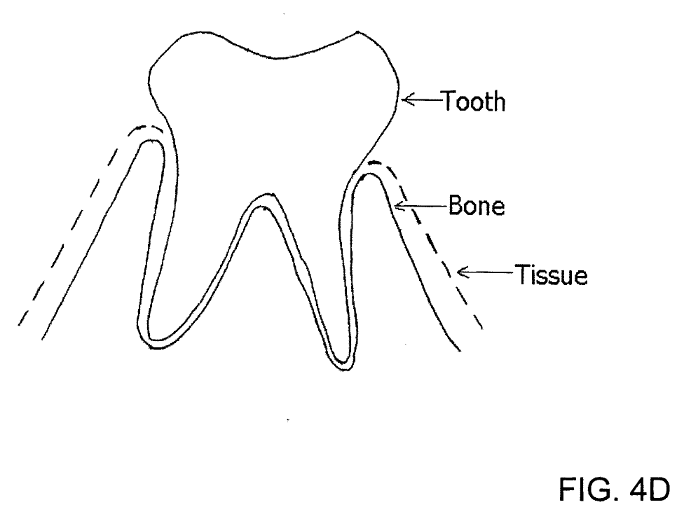

The bone scan and surface scan data of the patient's mouth are combined by superimposing the bone scan data with the surface scan data. For example, the surface contours of the tissue and tooth crowns may be aligned with the image data obtained from the bone scan by matching common crown features. This process is depicted in FIGS. 3-4.

FIGS. 3A and 3C show bone scans for an anterior and posterior tooth. FIGS. 3B and 3D show the surface scans for these teeth, respectively. In one embodiment the scan data is matched, aligned or correlated by identifying the matching crowns displayed in each of the images. This process is depicted in FIG. 4A (anterior tooth) and FIG. 4C (posterior tooth). The matching may be done by simple visual inspection of the two images, or by an automated process, e.g., using pattern recognition software. Once this match is found, the two images are superimposed over one another. From this combined set of image data, a tissue model can be extracted. By subtracting the volume data represented between the two scans a tissue model can be created. That is, by differencing the volume occupied by the anatomic structure shown in the bone scan (bone and tooth) from the volume depicted in the surface scan (tissue and tooth crown), a tissue model can be created. As a result, a separate model of the tissue can be combined with the crown and bone data, thereby creating a model of an arch that includes representations of tooth, supporting bone and gingival tissue as separate anatomical structures. This combined model for the anterior and posterior tooth is depicted in FIG. 4B and FIG. 4D, respectively.

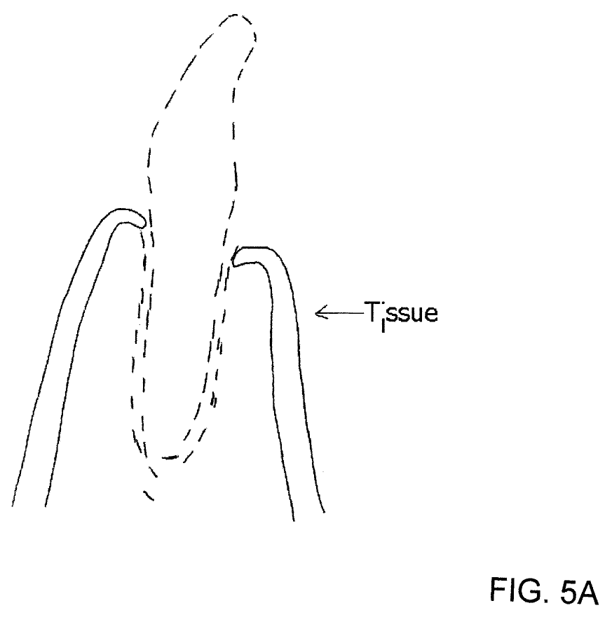

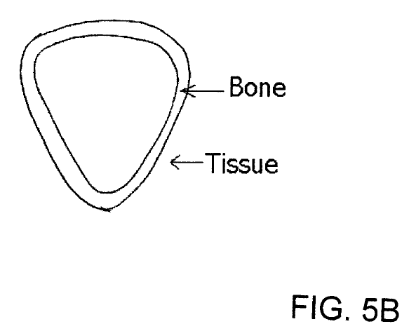

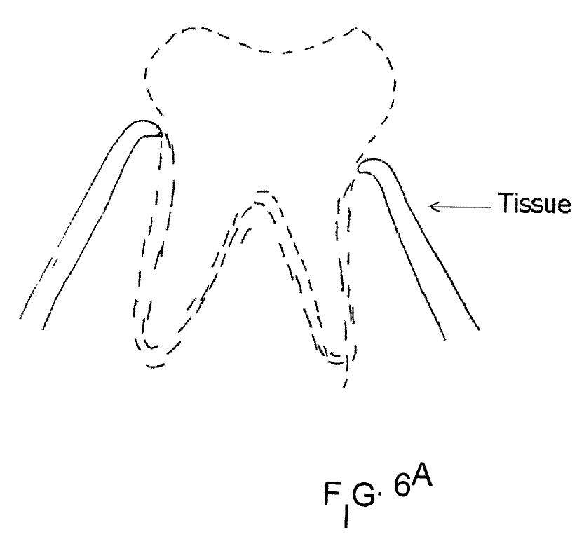

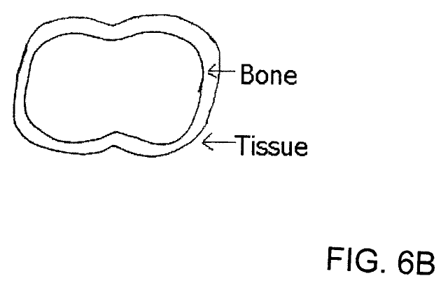

One aspect of the pre-treatment mouth model (PTMM) that departs from the known art is this representation of the tissue, both the surface contours and depth of the tissue layer surrounding the jawbone and teeth. By constructing a separate representation of the tissue, e.g., preferably by superimposing the bone scan data with the surface scan data, it is possible to obtain a better aesthetic restoration representing an ideal emergence profile from the tissue than previously thought possible. This tissue model may be used as a basis for modeling the gingival tissue after the implant is placed in the patient's mouth, for planning a customized tissue punch and an abutment suitable for the patient's gum line and topography. The accurate and customized tissue punch will preserve the original papilla, following the tooth contour more closely, and hence enable tissue to heal properly, and most importantly, prevent severe tissue shrinkage after implant placement, which is a common side effect of the current implant process where tissues are either punched using a circular punch or an incision is made and the tissue are completely flapped and traumatized. In another aspect of the disclosure, a gingival model is used to arrive at the correct tissue punch. For purposes of this description, the term “tissue model” will be used to refer to the model of the patient's tissue before the implant, and the term “gingival model” will be used to refer to the model of the patient's tissue after the restoration is completed. A depiction of a tissue model side view and top view (showing the contours of the tissue with respect to the underlying bone and bone socket, respectively) for the anterior and posterior tooth models of FIGS. 4B and 4D is depicted in solid lines in FIGS. 5A and 5B and FIGS. 6A-6B, respectively.

After superimposing the bone scan data with the surface scan data, the tooth crown surfaces may be separated from the tissue surfaces. In this sense, the tooth crowns refer to the exposed portion of the tooth that was obtained form the surface scan data. In one embodiment the tooth crowns represented in the surface scan data replace the corresponding crowns from the bone scan data. Since the surface scan data tends to be far more accurate, this can lead to a more accurate depiction of the dentition in the mouth model. The crowns may be “stitched” using graphics tools, such as a fusion method, to attach the crown from the surface scan data to the top of the root portion, e.g., the CEJ, from the bone scan data. As such this method will provide a more accurate tooth model. One particular advantage to forming a mouth model according to this process is enhanced accuracy in drill guide design based on a tooth and jawbone model. The currently known CAD/CAM drill guide processes rely on crown data from a CBCT scan, which is usually far less accurate than crown information obtained from a surface scan. Being less accurate, the drill guide is prone to errors in both drill depth as well as orientation relative to the jawbone since it is based on a relatively inaccurate model of the crowns.

The PTMM is a model constructed to provide predictions on the mouth anatomical structure. The term “predictive model” (or alternatively, analytic or mathematical model) is intended to mean a model of the mouth that can be used, not only to show volumetric information about the anatomic structures, such as how the tissue is situated relative to the crowns and jawbone, but also how the mouth operates from the standpoint of the biomechanics of the teeth and jawbone when the individual teeth are loaded.

According to one embodiment, the PTMM and mouth and missing tooth model (MTM), discussed below, is used to predict the load vectors on teeth. The load vectors are obtained from resolving vector forces on the surfaces of teeth as determined from the occlusion data and surface contours of the teeth. According to these embodiments, the bone structure, root and crowns of teeth may be modeled as rigid bodies. With such a model the restorative dentist can be quickly informed of the implications of such behavior as the interaction between upper and lower jaws that results in a non-uniform or oblique loading on teeth and the supporting jawbone, the effects of tooth spacing or tilted rotated tooth positions and the resulting atypical loading that results on the supporting bone and teeth. These sometimes, but not always subtle characteristics of a patient's dentition can have a profound impact on the longevity of an implant if the implant planning and selection does not take this factors into account. Indeed, when a restorative dentist does not take these factors into account, as is not uncommon, but rather bases his or her decisions solely on the aesthetics of the implant or safe locations for drilling a hole in the patient's mouth, there is the potential that the patient will need to return once again for an Occlusal adjustment, porcelain chipping and fracture of the fabricated crowns, or corrective surgery including but not limited to bone augmentation procedures and tissue grafting as well.

According to other embodiments, a mouth model may be formulated into a finite element or finite difference representation of the stiffness and strength characteristics of the anatomic structures. Techniques for constructing such a model and modeling a loading on teeth and the jawbone are known. Information used to construct this type of analytic model include stiffness/strength characteristics for different bone types, tooth enamel, periodontal ligament etc. Strength/stiffness characteristics of the anatomic bodies include such parameters as the elastic modulus, yield strength, ultimate strength, elastic/inelastic ranges, failure states and crack propagation characteristics, which may be integrated into a coupled structural stress/strain model. Thus, according to these alternative embodiments, a more precise load distribution over the mouth may be realized since the anatomic structures are no longer assumed to act as rigid bodies.

In other embodiments, a hybrid rigid body and flexible body mouth model may be constructed. For example, the jaw bone and tooth enamel may be modeled as rigid bodies, while the supporting periodontal ligament, for example, coupling the jawbone to the tooth would be represented as a flexible body.

After construction of the PTMM, the attributes of the missing tooth are determined and incorporated to arrive at a missing tooth model (MTM). That is, the size, shape and loading of the missing tooth are included into the model as if it were not missing from the patient's mouth. The determination of the appropriate implant, i.e., size, location, orientation of the fixture, abutment and crown is formulated based on the properties of this modeled tooth. Thus, according to the disclosure a method for restoring a missing tooth is formulated on the basis of the functional and aesthetic features of a modeled missing tooth, prior to any corrective surgery. The fixture screw selection, its location and orientation is not merely determined from the available jawbone structure for supporting an abutment and crown, or the skill and experience of the particular restorative dentist. Rather, it is based on how a natural tooth, including its crown and root, would function in the mouth.

Thus, it will be apparent that a method according to the disclosure departs in several aspects from the known implant planning and selection procedures. According to the disclosure, implant planning and fabrication for the final restoration is completed before any decisions have been reached as to the type of fixture that is needed. As discussed earlier, present implant planning and selection begins with a referral to an oral surgeon who makes a determination of the size and type of fixture screw based on the anatomy of the bone structure, such as bone density and health, the need for restorative surgery of the jawbone, proximity of nerves, etc. Little if any consideration, however, is given for how the implant is expected to function or how the selection of the fixture location, size and orientation might affect the aesthetics or longevity of the implant.

For instance, according to existing procedures, a screw may be placed in the patient's mouth based on the available dense bone or, if there is insufficient bone to support the tooth, the type of screw that can be supported when the jawbone is restored. Considerations such as the spacing between teeth, bite registration and/or chewing pattern and related loading on the implant crown, and/or aesthetics of the finished implant with respect to the adjacent teeth or gum line are not factors typically considered, at least from the standpoint of the known systematic approaches for implant planning and selection. Implant planning and selection today can produce a desired end result when the restorative dentist can draw from years of skill and experience in restorative implants. It is desired to have these skills become part of a systematic approach and not be dependent upon the unique skills of a restorative dentist.

Generally speaking, an oral surgeon is usually, if not only concerned with how to safely drill a hole in a patient's mouth and hold an off-the-shelf fixture in the mouth based on an assumed loading and orientation of the final implant. For instance, the oral surgeon is usually only concerned with avoiding nerves in the lower jaw or penetrating the sinus cavity, which is located above the upper jaw. However, this generalization of how a tooth will function in the mouth often results in later complications, or unacceptable approximations/errors effecting a patient's satisfaction with the finished product. A tooth is not infrequently subjected to oblique loading due to a patient's peculiar bite or chewing patterns, or relationships between the implant and surrounding teeth or other imperfections which over the long run can result in subsequent corrective replacement or surgery. According to the disclosure, these aforementioned ad-hoc measures for design and planning of the fixture screw are replaced by a systematic process for implant planning and selection that establishes the criterion based on an analytic, predictive or mathematical model of the mouth that includes a representation of the missing tooth, as it would naturally sit in the mouth.

According to another aspect of the disclosure, a missing tooth model, or MTM, is constructed. This missing tooth model may be used to determine the optimal properties of the implant suited for performing the function required of the missing tooth. Hence, the missing tooth model data (discussed below) can lead to better selection of a screw type, pitch, size, angle of insertion, etc. since the functional aspects of the missing tooth are derived from the unique biomechanics of the patient's mouth. A missing tooth model may be constructed using one or more of the following techniques. During the course of the discussion, the examples make reference to a user software tool that includes an interactive graphical user interface (GUI). Using this tool, a tooth and root may be modeled graphically. That is, the tool is used to generate a proper shape and position in the mouth based on the spacing and location of the supporting bone and adjacent teeth, chewing pattern, spacing between teeth, etc. Further, the shape of the crown may be constructed in relation to the adjacent teeth to achieve a pleasing appearance for the artificial crown. This process may be iterative using GUI methods, such as click and drag, cut and paste, rotation in three-dimensional space, etc.

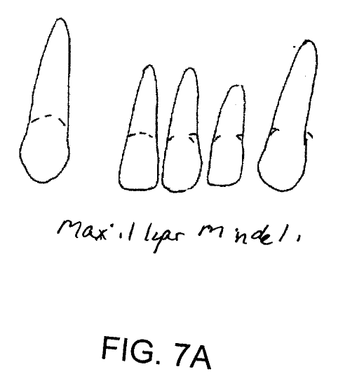

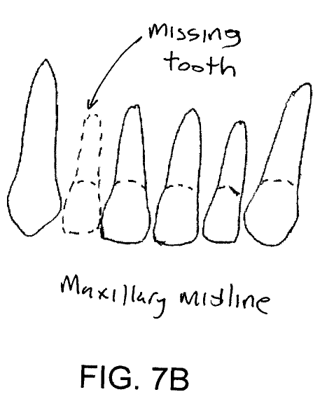

According to one embodiment, selection of the crown and root for the missing tooth may utilize one or more modeling steps. In one embodiment, a three-step process is followed. In the first step, the user selects the stock crown model, which is defined in a local coordinate system, and is translatable, rotatable and resizable along each of three orthogonal axes in the mouth model, i.e., it can be manipulated in three-dimensional space and has nine degrees of freedom (translation, rotation and sizing). The stock crown or tooth types may be based on the location of the missing tooth. In one embodiment, a stock or generic tooth crown is created by mirroring the tooth shape located on the opposing side of the arch, as depicted in FIGS. 7A-7B. The missing tooth crown (FIG. 7B) may be scaled and orientated appropriately according to where it will sit in the mouth and the available space between the adjacent teeth. In general, the shape, size, and orientation of the crown may be selected using one or more of the following criteria

1. Tooth type

2. Patient age and sex

3. Patient arch characteristics e.g. arch length, curve of spee.

4. The adjacent teeth characteristics

5. The opposing arch characteristics and occlusion of the mouth.

In steps two and three of the process, a crown and/or root may also be shaped to achieve an optimal bite, natural position or formation relative to the jawbone and/or adjacent teeth, based on factors such as the teeth occlusion. Steps two and three may be utilized to arrive at a customized shape for aesthetic reasons, for functional reasons or both.

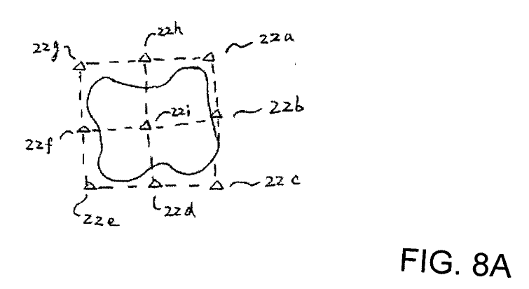

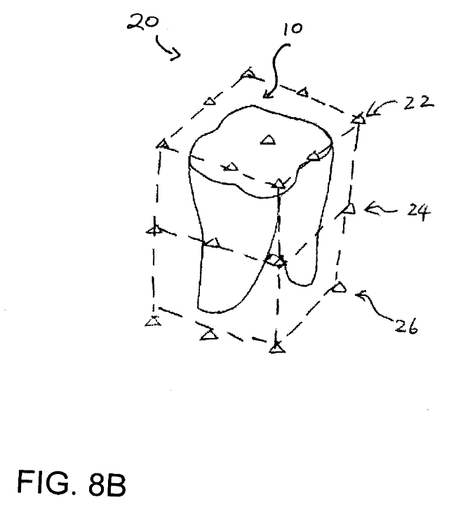

Referring to FIGS. 8A-8B, in some embodiments step two, i.e., the step following the initial sizing and placement of a stock tooth uses a control box method for the initial shaping of the crown, midlayer and/or root portions of the missing tooth. For example, in FIGS. 8A-8B a control box 20 is used to manipulate the shape of the stock tooth shape (or generic tooth shape) 10 following step one. FIG. 8A shows a top view of the tooth model 10 relative to the control box 20. Shown is the crown portion 12 enveloped by the control box 20 portion for the crown (portion 22). Preferably, the control box 20 has three or more sub-sections corresponding to different portions of the tooth and each sub section has nine associated control points that can be moved relative to each other to create customized surfaces for each section of the tooth.

In FIG. 8B the perspective view of the control box 20 and tooth 10 has a top volume or above-the-gum portion 22 corresponding to the above-the-gum part of the crown, a tissue margin volume layer or portion 24 enveloping the portion of the crown that is covered by the gum tissue, and the bottom or root layer or portion 26 that envelopes the root of the missing tooth. Each section 22, 24, 26 has associated with it nine control points that when moved in three-dimensional space change the portion of the surface associated with that control point. As such, by manipulation of the locations of the control points, a more customized tooth shape can be formed. FIG. 8A shows the nine control points 22a, 22b, 22c, 22d, 22e, 22f, 22g, 22h, 22i for the above-the-gum portion 22. In other embodiments an automatic generation of the above-the-gum portion of the crown, tissue margin layer portion and root portion may be used in the alternative, or in addition to manual control of the control points. The auto-generate embodiment may utilize logic that draws from the spacing information inherent in the mouth model, volumetric or inter-geometric constraints so that smooth transitions are generated between the crown, midlayer and root sections, rules for generating the missing tooth based on the one or more of the criteria listed earlier or heuristic rules based on experience and know-how from practice.

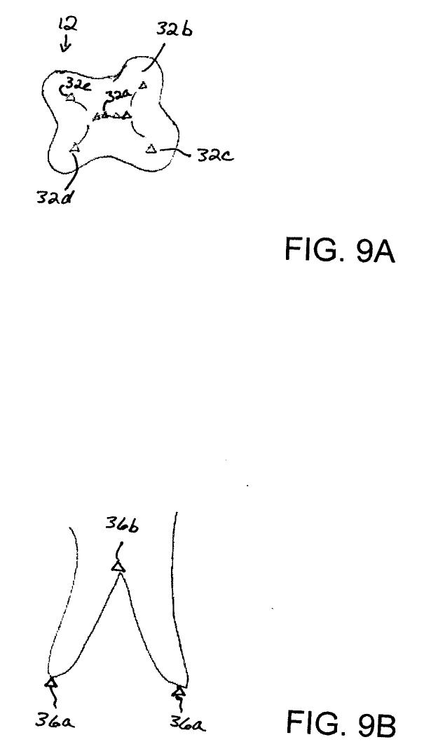

In addition to a manual control box method, the auto-generate embodiments or in the alternative to these methods for shaping/sizing portions of the missing tooth, the tool may also include a capability for dragger local surface features to reshape/resize the missing tooth model. In a preferred embodiment, this is the third step, after steps one and two. For example, in FIG. 9A local dragger 32a corresponding to a central groove, and local draggers 32b, 32c, 32d and 32e corresponding to the four cusps of the biting surface of the crown 12 may be included as part of the crown model portion of the missing tooth model. The local draggers 32 are movable nodes that allow specific portions of the tooth model to be moved in three or two dimensional space to create a customized surface geometry. By including these movable dragger points in the model, the missing tooth model can be conveniently modeled to achieve the desired end product, such as to accommodate a particular registration pattern or occlusion. FIG. 9B shows a corresponding root tip dragger 36a and root furcation dragger 36b that allows the root portion of the missing tooth model 10 to be re-shaped, e.g., to accommodate or achieve a more realistic fit with the supporting ligament or jaw bone.

According to some embodiments, shapes for the surfaces may also be arrived at by, e.g., iteratively determining the biting surface shape or crown and root body that reduces stress/strain on the enamel or supporting jaw. In these embodiments, a finite element model (FEM) may be utilized to predict the stress/strain distribution for the missing tooth model and associated anatomical structure supporting the missing tooth. A stress distribution is computed for a first body, the contour of this body is then modified to reduce the stress concentrations, then the model re-run to arrive at an improved or optimal shape from the perspective of reducing stress concentrations. Mesh generation algorithms are available that can efficiently regenerate an FEM in order to perform this type of iterative or step-wise analysis on a desktop computer. This technique may also be utilized to identify key load points for implant planning and selection, as described in greater detail, below.

After the missing tooth shape has been selected, or as part of the tooth shape selection process, a cut shape for the tissue punch and the gingival model may be determined for the missing tooth. This modeled cut or punch is part of a gingival model incorporated into the missing tooth model. Unlike existing methods for a tissue punch, the disclosure describes a method for producing a tissue punch that matches the natural contours of the missing tooth. Additionally, the tissue punch accounts for factors such as permitting proper blood flow within the papilla between teeth and the natural position of the missing tooth relative to the gum line. With a properly designed tissue punch, the tissue will heal in such a way as to produce a more natural contour, as planned in the digital design. In the existing methods a tissue punch simply creates a circular hole to accommodate the fixture.

The associated gingival model (i.e., a model of the tissue after implant is installed) is based on the tissue model created earlier. The gingival model is, in general, based on the patient's dentition and tissue geometry relative to the dentition, including the depth of the tissue. Preferably, a software tool is used to enable a user to pre-define and sculpt gingival contours and emergence profiles of teeth for optimal tissue recovery minimizing unfavorable shrinkage and maximizing aesthetics. The gingival model is discussed in greater detail, below, in connection with methods for abutment design.

The mouth model is used to predict load vectors associated with the missing tooth. In contrast to existing methods, load vectors derived from a model intended to mimic the features of a natural tooth and the biomechanics associated with that tooth's proper function should result in a much more informed planning and selection process for the implant. The load vectors are those that can be used to characterize the loading on the crown of the missing tooth, which is a function of its orientation in the mouth, the sharing of the loads with its neighboring teeth, the eccentricities associated with the occlusion or chewing patterns, the abutting surfaces and the type of supporting bone underneath. In some embodiments the load vectors may be represented by resolving a set of two or more vectors acting on the cusps of the missing tooth, while in other embodiments the load vectors can be a product of a more detailed distribution of forces produced from an elastic body analysis.

From this information an improved product and process for planning and selection of an implant, customized for a patient's unique condition, becomes possible. This implant selection also, of course, takes into account the other factors bearing on the proper implant selection and surgical procedure (e.g., location of nerves, depth of the jawbone, etc). The mouth model preferably incorporates these other considerations structures as well. Thus, in some embodiments the mouth model provides the complete anatomic model, which provides all required information, whether an inquiry is made by the consulting dentist, restorative dentist, or oral surgeon.

In some embodiments the load vector analysis may proceed by identifying key loading points, for example:

1. Cusp Fossa.

2. Cusp embrasure

3. Buccalized

4. Lingualized

The Cusp Fossa load vector may be regarded as the primary, or predominate load vector that determines the type, and location of the implant needed. Other selections of primary load vectors and/or secondary load vectors influencing implant selection may be part of the selection process.

According to one method, a load point is determined based on the surface contact between teeth and direction of the biting/grinding between teeth, the occlusion, biting patterns, etc. as determined from the mouth model. From this information the load vectors are determined from a geometric averaging of the individual loading points or rigid body resultant force determination computed from a free body representation of the missing tooth.

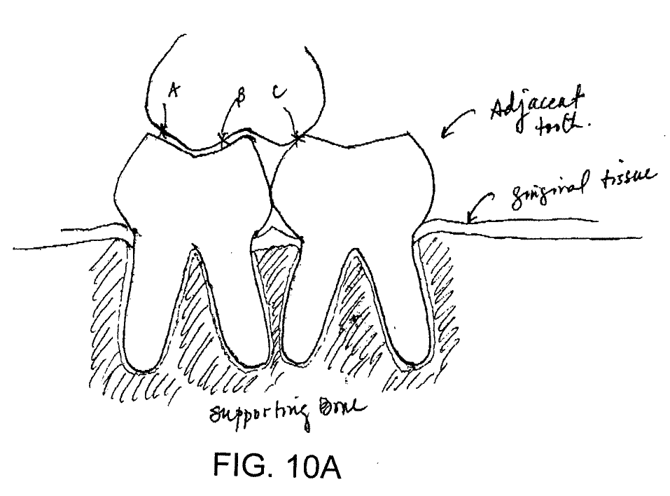

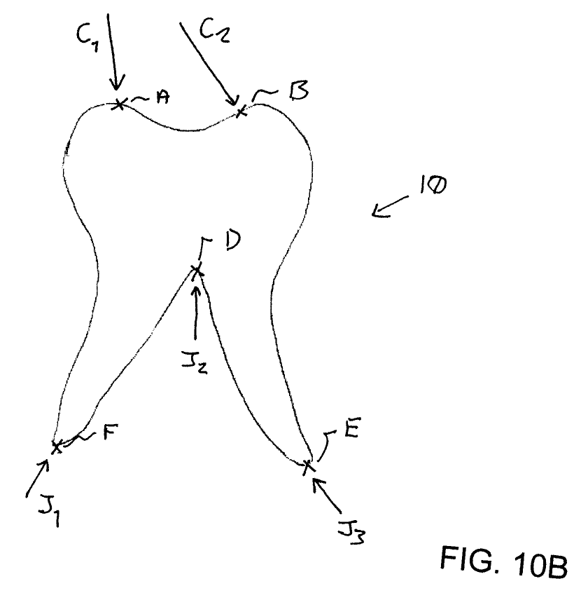

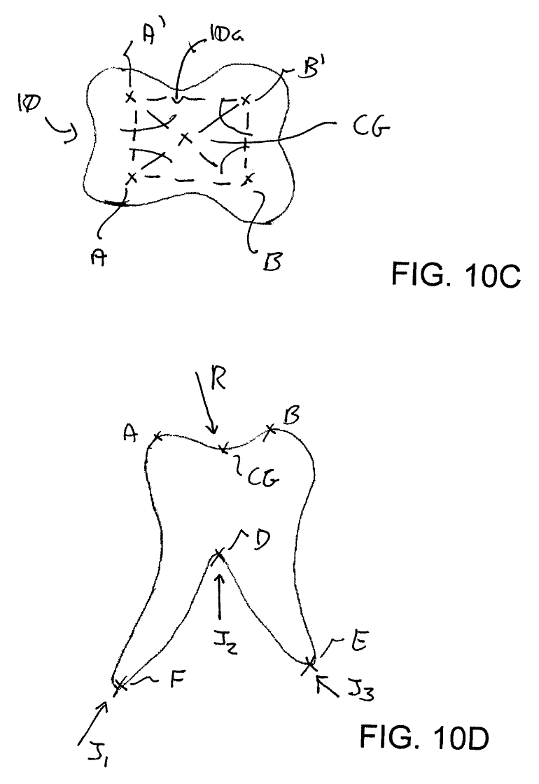

FIGS. 10A-10D provides an example. FIG. 10A depicts a set of three posterior teeth of the patient's mouth model. The two lower teeth of the lower arch are the missing tooth 10, an adjacent tooth, and an abutting tooth from the upper arch that comes into contact with both the missing tooth 10 and the adjacent tooth according to the patient's occlusion. The contact points between the upper tooth and the two lower teeth are indicated as points A, B and C. The direction of a force vector at points A and B may be determined from an averaging of the pressure applied over a surface of the crown. For instance, the average or net of the surface normal directions of the surfaces of the left cusp in contact with the abutting tooth (location A in FIG. 10A) is the direction of the force vector C, at point A. From the mouth model the set of equal and opposite forces acting between the abutting tooth, adjacent tooth and the missing tooth model may be solved for using a set of linear equilibrium equations. The net force applied to the lower arch by the abutting tooth in FIG. 10A may be approximated using any known method.

Referring to FIG. 10B, from the solution of the set of linear equations the equilibrating forces acting upon the missing tooth may be found. In this example, the vector forces, i.e., magnitude and direction, acting on the cusps are C₁ and C₂ and the simplified reaction or equilibrating forces applied by the jawbone at points E, D and F are J₁, J₂, and J₃. FIGS. 10C and 10D show the resultant vector force R of the four cusps A, B, A′ and B′ with respect to the jawbone force vectors J₁, J₂, and J₃. In the example depicted in FIG. 10C, the location of the point CG for the resultant force vector R is shown. The average or equivalent rigid body resultant force R are CG is found by locating the intersection of the triangles. As shown, the resultant force vector R is skewed significantly, i.e., not normal to the grinding surface of the crown, as might otherwise be assumed. This result may be due to a variety of causes, such as the optimal shape of the crown for the missing tooth, the occlusion, orientation or rotation of teeth, or the spacing between the missing tooth 10 and the adjacent tooth, which can effect the load sharing among the contact surfaces represented as points A, B and C in FIG. 10A. Without the benefit of an accurate model for predicting loads via a missing tooth model, the effects of an eccentric loading of the implant, which reflects a patient's unique condition, can be overlooked.

As will be apparent, the loading of the missing tooth can be quite different from what might be expected during the planning and selection process if only the safe areas for drilling the fixture hole are taken into consideration. The present method, therefore, departs from the known techniques for implant planning and selection because more is taken into consideration than simply the safety of the patient and the availability of dense bone structure to support the tooth. The methods for implant selection and planning according to the disclosure can enable the practitioner to accurately place dental implant fixtures based on the actual interaction of the teeth. This reduces risks of potentially severing certain anatomical structures/nerves in the jaw bones, or otherwise leaving the patient with an uncomfortable sensation when the implant is loaded that may lead to eventual loss of the fixture.

As demonstrated in the above examples, according to some embodiments the MTM may be constructed as a set of rigid body representations of the tooth crown and root connected to the jawbone structure. In other embodiments, the teeth may be modeled as rigid bodies, while a flexible connection is provided between the supporting jawbone and root, e.g., representing the periodontal ligament or less dense bone structure. According to other embodiments, the load vectors may be arrived at using a finite element model (FEM) representation of the tooth and jaw. This model can produce a stress/strain distribution for the missing tooth model and associated anatomical structure supporting the missing tooth. From this data the stress distributions can be averaged and then used to compute a set of key load vectors for the implant design.

The above model data provides the information needed to make a well-informed decision on the type of fixture needed, which is modeled as part of the third and final model, called the appliance mouth model (AMM). The MTM provides the basis for selection of the fixture based on the load environment, including the anatomical structure available for supporting the predicted occlusion loads. The practitioner can better approximate biomechanical/structural properties for selecting (1) type of fixture; (2) size and length of fixture; (3) fixture orientation; and the (4) fixture depth. In addition, the disclosed methods can facilitate a more intimate fixture or appliance manufacturer-doctor relationship that will streamline the process for producing customized and more functionally appropriate implants by sharing information computed from the MTM. In the preferred embodiment, this relationship is enhanced by providing a communication medium over the community portal (FIG. 2D).

As discussed earlier, this manufacturer-doctor relationship may, for example, be facilitated through a third party network service provider who can transmit some or all of the information about the missing tooth model from the doctor to the manufacturer over a secure, authenticated network connection. In some embodiments, the fixture manufacturer may be provided with essentially a set of characteristic load vectors and two-dimensional drawings illustrating where the fixture is needed and the depth of supporting bone. The load vectors may be defined in terms of a natural tooth, or the corresponding loading points on the fixture, abutment and/or artificial crown. Or the fixture manufacturer may be provided with a three dimensional model that illustrates the forces acting on the missing tooth, or the combined missing tooth and supporting jawbone model (extracted from the mouth model). From this information the manufacturer can fabricate a customized fixture that mimics the biomechanical features of the missing tooth as predicted using the MTM. The community portal may also, through an application/file server, allow the manufacturer to provide suggestions in the form of model annotations/notes to the doctor based on an assessment of the type of screw or abutment that can be manufactured to meet the functional requirements predicted by the model.

At this point, the practitioner can appreciate the type of fixture that is needed, and the depth and orientation of the hole or osteotomy which will receive the fixture. The foregoing will also inform the practitioner of the nature of the load bearing surfaces for the artificial crown, and the dimensions of the crown. Hence, a decision may be reached as to the type of fixture and crown needed. The other aspect of the implant to consider is the abutment. According to one embodiment, the abutment design is based on the defined load vector.

According to another aspect of the invention, an abutment modeling method, included as part of the AMM, is provided. The abutment, which functions as the interface between the crown and implant fixture, is an aspect of the implant which, if not designed properly with regards to the patient's gum line and/or adjacent teeth, can easily distinguish the implant from the adjacent natural teeth, which of course is not desired. According to some embodiments, an implant design therefore includes a design of the emerging tooth profile, i.e., the portion just above the gum line that mimics a natural tooth emerging profile. The design process may be summarized as follows:

1. During formation of the abutment, or crown model, ensure there is enough space to allow for papilla (i.e., the small projection of tissue at the base of the crown) to grow in the space between the teeth, and sufficient space for blood circulation through the papilla;

2. The abutment section should have a smaller diameter as determined from the occlusion table. This consideration reflects the fact that teeth bearing a majority of the grinding/eating load tend to have smaller emergence areas as compared to their crown.

3. Model the abutment as four separate control layers, or abutment modeling controls. These layers may be referred to as the fixture layer, tissue contour, crest height and tissue margin layer.

Layer 1. The fixture layer of the abutment is the defined surface of the abutment bottom layer that will provide an intimate seal between the implant fixture top platform layer and the bottom platform of the abutment. This intimate abutment/implant interface layer seal is necessary to prevent bacterial leakage that can contribute to bone loss around the fixture head.

Layer 2. The tissue contour layer of the abutment defines the geometric shape, thickness and height of the tissue that it supports between the crest of the bone. It is usually flush with the fixture head and the crest of the tissue around the CEJ of the tooth. Various tissue contour layers of the abutments may be necessary for different teeth in the mouth, especially in the cosmetic anterior zone where optimal support for the Interproximal Papilla is required.

Layer 3. The crest height of the abutment layer defines the geometric shape of the abutment, about 0.5 to 1.0 mm below the crest of the tissue around the CEJ of the tooth. This presents optimal support for the tissue as it related to the emergence of the tooth or clinical crown out into the oral cavity.

Layer 4. The abutment margin layer defines either a shoulder or a chamfer margin for the tooth that will be cemented to it. A shoulder margin is usually needed for an all-ceramic crown. The shape of this layer is usually a horizontally geometrically shrunk version of the crest height layer by about 1.5 to 2 mm. A chamfer margin is needed for an oxide ceramic Zirconium or alumina coping that gets porcelain stacked to it to fabricate the final crown.

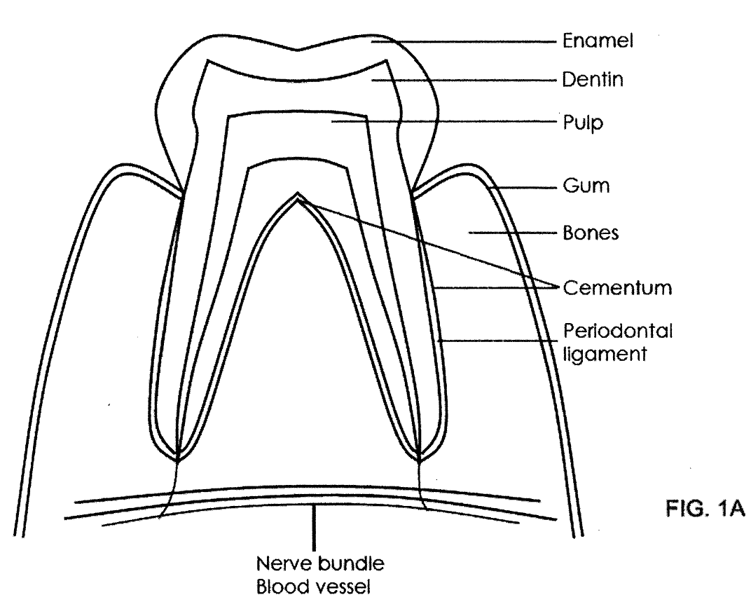

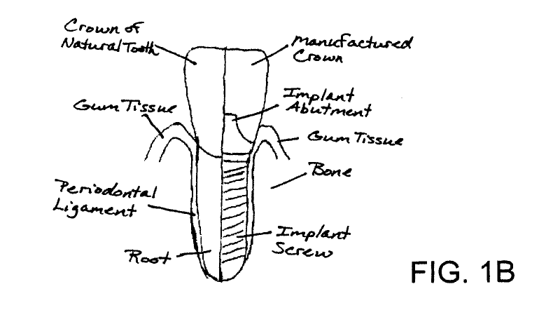

FIG. 11A illustrates these four layers in a similar split-view format as FIG. 1B. To the left is the missing tooth model 10 from the mouth model and to the right is the implant 10′ equivalent of the missing tooth. The layer between the root and crown (or screw and abutment) is the first layer 42, e.g., fixture layer, followed by the second layer 44, e.g., tissue contour layer, followed by the third layer 46, e.g., crest height layer, and then layer four 48, e.g., the abutment margin layer. Each of these layers may be adjusted independently of each other using a GUI tool to achieve the desired surface for promoting tissue growth that will mimic the gingival surrounding a natural tooth. FIG. 11B shows a top view cross-section of the tooth model 10. As depicted, the layers 42, 44, 46 and 48 may be independently adjusted relative to each other by including control points (in this example six control points such as 46a and 48a) to produce the desired shape for the abutment 40. In some embodiments one or more of the layers 42-48 may include surfaces formed as square, v-shaped or round grooves to promote the desired tissue growth near the abutment. The grooves may be formed to model the Interproximal Papilla, which promotes tissue adherence to the sides of the tooth. According to this embodiment an abutment modeling the Interproximal Papilla and the natural shape of the tooth between crown and root abutment (i.e., looking downward into the tooth socket), in combination with a tissue punch having a cutting surface conforming to this natural shape can produce a healed tissue surrounding the implant that will have a more natural appearance and emergence profile from the gingival tissue than previously thought possible for an implant.

According to one embodiment, there are three types of characteristic abutments that are modeled using the missing tooth model. They are the healing abutment, temporary abutment and final abutment. Each abutment design is based on the gingival model. That is, each of the abutment models are designed for purposes of ultimately forming, as through cooperation of one to the other, a sculptured gingival shape surrounding the final implant/tooth emergence profile.

The four layers (FIGS. 11A-11B) may be constructed using the following guidelines:

For layer 42 the size would be selected based on the size of the implant fixture platform, either internal or external. The platform size would be determined from the earlier load vector analysis, which reveals the type of screw platform needed, orientation of the screw, etc.

For layer 44 the geometry of the corresponding portion of the root form at this layer is reproduced, i.e., layer 44′ from FIG. 11A, or the equivalent root forms from adjacent teeth. From this initial sizing, the control points may be used to adjust the dimensions according to the available spacing, areas available for papilla, etc. as discussed earlier.

For layer 46 there may be an upper edge at the upper Y-axis Crest Height of the abutment. The geometric shape of the abutment may be placed 0.5 to 1.0 mm below the crest of the tissue around the CEJ of the tooth. This presents optimal support for the tissue as it related to the emergence of the tooth or clinical crown out into the oral cavity.

For layer 48 the abutment margin layer defines either a shoulder or a chamfer margin for the tooth that will be cemented to it. A shoulder margin is usually needed for an all-ceramic crown. The shape of this layer is usually a horizontally geometrically shrunk version of the crest height layer by 1.5 to 2 mm. A chamfer margin is needed for an oxide ceramic Zirconium or alumina coping that gets porcelain stacked to it to fabricate the final crown. A chamfer margin can be used to orient the crest by, e.g., 5-10% based on the mouth model, adjacent teeth, etc.

### EXAMPLES

The following provide examples of methods of design and ultimate manufacture of a healing, temporary and final abutment, temporary and final crowns and bridges, and a surgical guide.

The healing, temporary and final abutment may have a unique design and manufacturing process. For a healing abutment:

1. Define the core of the abutment height and width “#5”—The core should be between 1-7 mm in Height.

2. Insert the axis hole chimney

3. Export a STL file for 3-D printing

For a temporary abutment

1. Define the core of the abutment height and width “#5”—The core should be between 1-7 mm in Height. Then define the body of the abutment shape, height and angulation.

2. Insert the axis hole chimney

3. Export a STL file for 3-D printing

For a final abutment:

1. Define the core of the abutment height and width “#5”—The core should be between 1-7 mm in Height. Then define the body of the abutment shape, height and angulation.

2. Insert the axis hole chimney

3. Export a STL file for milling either in Titanium or Zirconium.

Provisional crown and final crown models are based on the tooth modeling and related analysis, as explained earlier. A crown design may be extracted and then later sent to a manufacturer, either as a design drawing or three-dimensional interactive CAD model. The steps for generating the crowns may be as follows:

i. Load the reverse engineered missing tooth,

ii. Delete geometry below gingival margin, mostly root model,

iii. Load abutment model, and

iv. Generate crown geometry by subtracting abutment model from the tooth model for an all ceramic crown or load the abutment model and add 0.8 mm to.1.2 mm to the entire geometry to design and fabricate a Zirconium or alumina coping.

In the case of a provisional bridge or frame, the design steps may be

1. Pick the corresponding designed abutments;

2. Align and insert the abutment into the tooth model;

3. Modify and adjust the occlusions with the opposing arch;

4. Modify and adjust the contacts with the adjacent teeth; and

5. Define the connector height and width above the gingival crest.

In the case of a final bridge or frame:

1. Pick the corresponding designed abutments;

2. Align and insert the abutment into the tooth model;

3. Modify and adjust the occlusions with the opposing teeth;

4. Modify and adjust the contacts with the adjacent teeth;

5. Cutback the crown contour by “1.5-2.0 mm”; and

6. Define the connector height and width above the gingival crest.

7. Define embrasure spaces

There are three types of surgical guides that may be used. They are a tooth supported, bone supported and mucosa supported surgical guide. A tooth supported model is preferably based on the information obtained from the surface scan, or from the surface information in the mouth model because this data can provide more accurate information about the patient's dentition. A procedure for creating a tooth supported surgical guide may be the following:

a. Produce the mouth model;

b. Identify the anchoring tooth from the mouth model;

b. Create an outer shell model of the surgical guide;

c. Load implant design data;

d. Insert drill guide cylinders; and

e. Union cylinder with shell model.

For a bone supported surgical guide, the accuracy of the guide is based on the accuracy of the bone scan data. Therefore, all artifacts of bad scan data should be considered when basing the surgical guide on the supporting jawbone. A process for a bone supported guide may be the following:

a. Identify the arch;

b. Create a out shell model of surgical guide:

c. Load implant design data;

d. Insert drill guide cylinders; and

e. Union cylinder with shell model.

For a mucosa supported guide one may use a radiopaque scan prosthesis, which clearly outlines the gingival tissue or a tissue borne removable prosthesis with radiographic markers on the buccal and lingual flanges. A duplicate of the scan prosthesis (visible in CT data) with inserted cylinders, may serve as the basic principle of a mucosa supported Surgical Guide. Production of the scan prosthesis according to the procedure below, and correct positioning of the scan prosthesis in the patient's mouth during the CT scan are important to ensure a successful transfer of the pre-operative treatment plan into surgery. Sufficient vestibular and lingual supports are relied on for correct positioning of this guide-type. Additionally, there should be enough supporting surface available in order to use a mucosa-supported surgical guide. The design process for a mucosa supported surgical guide may include the following steps:

a. Identify the arch;

b. Load the radio opaque guide;

c. Load the implant design data;

d. Superimpose and align b. and c.;

e. Insert drill guide cylinders; and

f. Union the cylinder with the shell model.

A radio opaque stent may be generated using the gingival modeling technique described earlier, in combination with CT bone scan data from the mouth model. The radio opaque stent may be fabricated/designed using the following steps:

1. Identify the arch;

2. Load gingival model;

3. Create radio opaque stent shell;

4. Load CT data;

5. Load implant design data; and

6. Superimpose and align data to one.

As mentioned earlier, according to some embodiments a software tool or suite of software tools capable of running a personal computer is used to perform one or more methods according to the disclosure. The software tool may be provided as a stand-alone application loaded on a doctor's local workstation or PC, provided through a network portal as a service of the restorative dentistry network community. The software tool may also be viewed as an enterprise-level software application intended for use by trained personnel with oversight from specialists in the field. Either of these embodiments is contemplated. In the case of an enterprise software tool, the software may additionally contain network components that would provide doctors/patients with creating 3D viewer files, i.e., files that are less bulky than CAD files and can be easily exchanged via E-mail or FTP. A 3D viewer file, e.g. Viewpoint 3D, may be annotated, have notes attached, etc., which enables it to be exchanged among doctors and appliance manufacturers and hence serve as an online communication medium.

In any case the software tool may be configured as follows. The tool or suite may provide a graphical user interface (GUI), menu systems, etc., which can be used to create models, export/import model data, modify a model or design, perform iterative analysis, evaluate potential designs, etc., based on the individual patient mouth model, which includes a digital representations of scanned articulated models of the upper and lower jaws, a tooth replacement design, an abutment design, a gingival model design, an fixture selection based on a patient bone structure, CT scans representing anatomical features i.e. sinus and nerves, measurement tools, digital data of the scanned impressions or stone models. Additionally, an interface is provided so that a treating physician can specify or provide feedback regarding such topics as fixture type, fixture position, a choice on immediate loading or delayed loading, and choice of occlusion, components (temporary/final or both).

Additionally, in some embodiments the software suite may include tutorial videos, and a web-based user driven tutorial that can allow doctors to review a particular type of treatment he/she is confronted with, e.g. replace a single unit of an incisor or replace with 2 implants, 3 units bridge. The major categories of tutorial video may include

i. Placement of the Surgical Guide

ii. Step by Step Drilling Process

iii. Fixture Insertion

iv. Removal of the surgical guide

v. Final Tissue Punching

vi. Attachment of the following based on Surgery:

1. Temp Healing Abutment

2. Temp Abutment

3. Temp Crown

4. Final Abutment

5. Final Crown

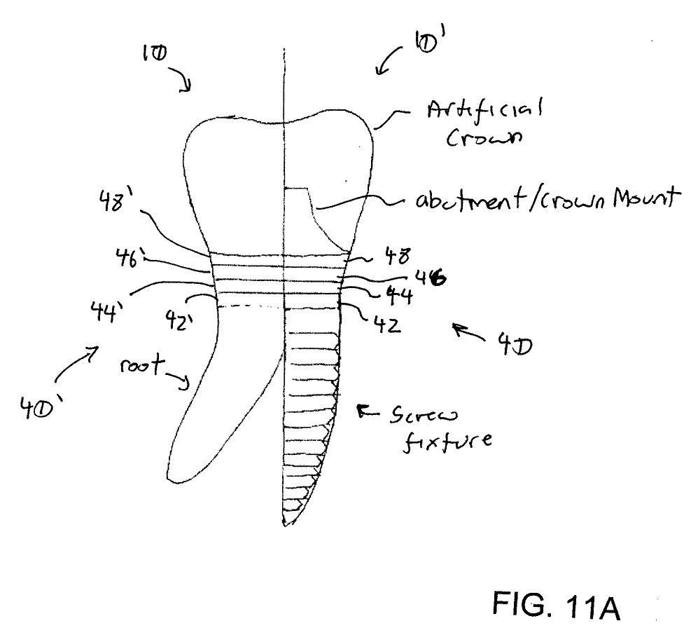

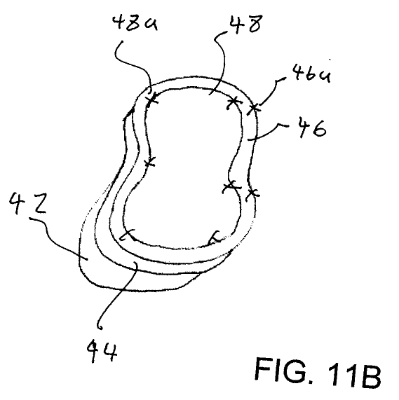

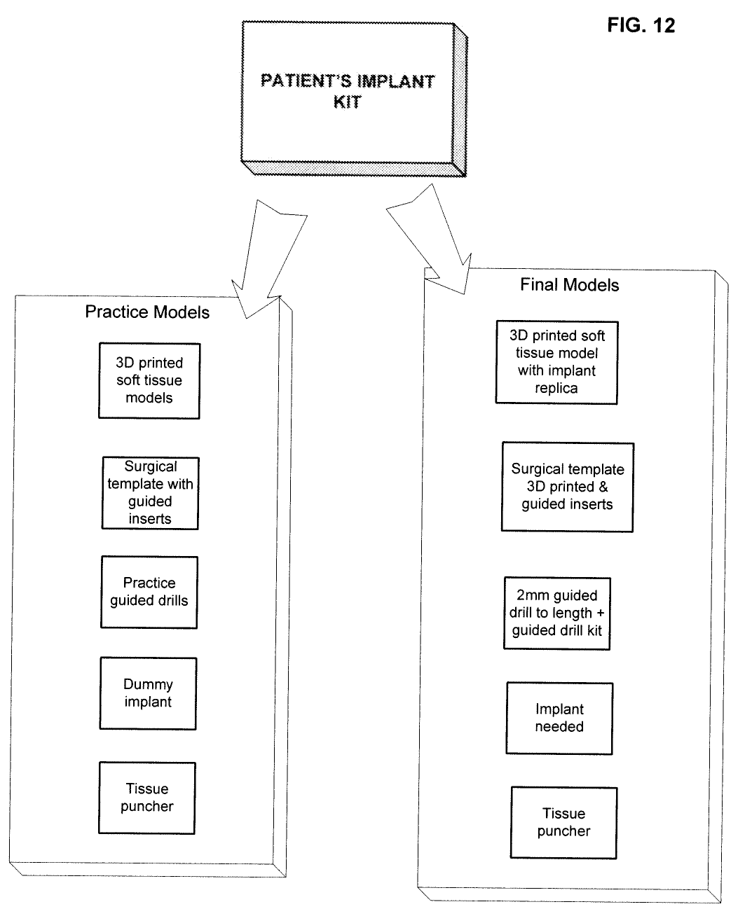

After formulation of the AMM, a recommended treatment solution is provided. In this aspect of the disclosure, there is a method, system and apparatus for communicating to a doctor a kit containing the appliances and roadmap for performing the restoration. Parts manufacturing may be accomplished by sending a copy of the AMM to an appliance manufacturer, who can use the information in the model to manufacture the part. Or the AMM can be sent directly to the doctor, as in the case where the doctor uses his/her own sources for appliance manufacture. The delivered kit may be packaged or organized so as to convey the steps for using appliances, including steps that are not known prior to the start of treatment. From the AMM physical replicas of the appliances can be made by various rapid prototyping machines. In one embodiment, a kit includes two parts: (1) a practice model kit before surgery, (2) Final model kit for surgery. Referring to FIG. 12, there is shown the basic components of these kits provided to the doctor. The kits may provide all elements of the implant, or a portion of the appliances, which can be later supplemented by ordering additional appliances through the online service.

A delivered kit may be packaged to reduce the complexity associated with the step-by-step process of dental restoration. The kit may be packaged in a logical order so that it is clear how the appliances should be used and in what order. This may be communicated through a step-by-step user guide, or by other methods to eliminate mistakes or misuse. The kit components may be separately packaged with peel-off covers that are numbered, by color coding, separately packaged, etc. or by other methods for communicating to the user how to use the contents of the kit. Additionally, the kit can take into account the possibility that a doctor may need to adjust a treatment plan based on patient response.

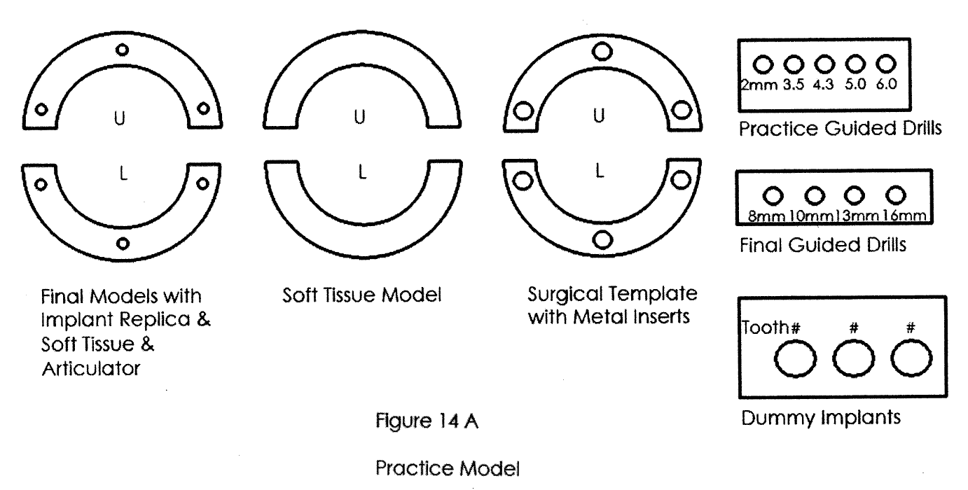

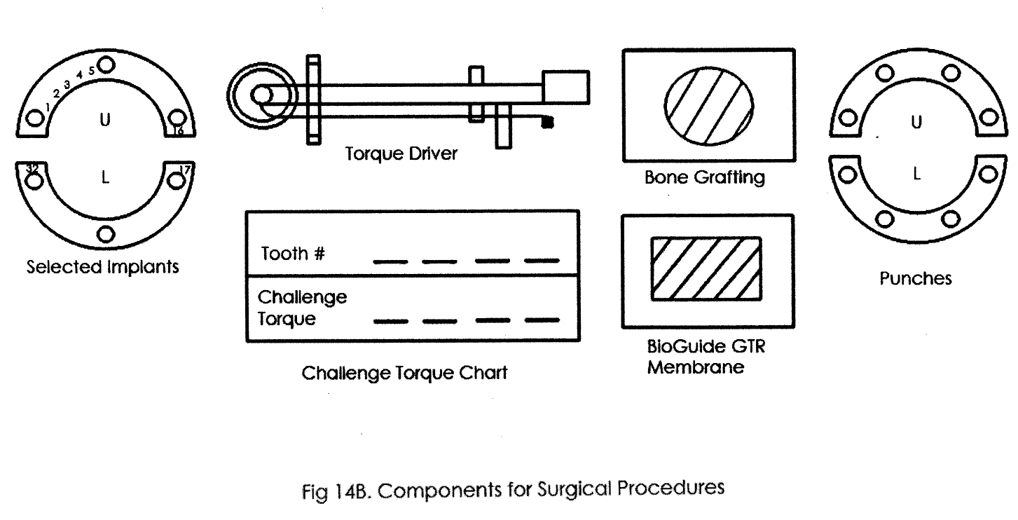

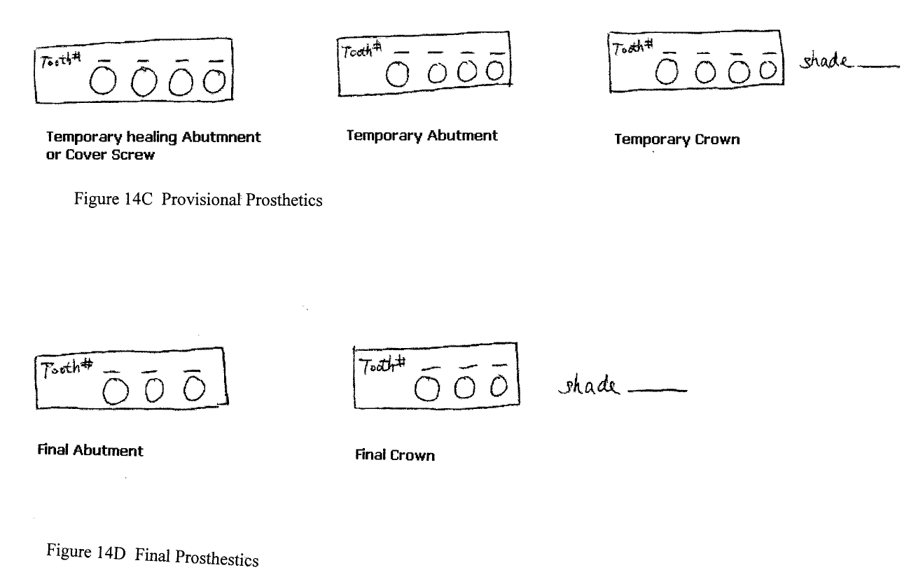

The elements of a kit are shown in more detail in FIGS. 14A-14D. In general, a kit may have four parts, sections or portions:

Practice Model. An example of this part of a kit is illustrated in FIG. 14A. Practice Model may include soft tissue models, a dummy fixture, and a practice guided drill bit. These components may be used to practice the implant procedure. The components are custom-made for the patient's condition. Thus, the practice models are essentially identical to the appliances that will be used during the actual procedure.

Surgical Components. An example of this part of a kit is illustrated in FIG. 14B. Surgical Components may include a surgical guide, 2 mm twist drill, guided kit, punch, implant screws, and final model which may also serve as a guide during the final procedure.

Provisional Prosthetics Solution An example of this part of a kit is illustrated in FIG. 14C. A Provisional Prosthetics Solution may include a cover screw, temporary healing abutment, temporary abutment, temporary crown and temporary bridge.

Final Prosthetics Solution. An example of this part of a kit is illustrated in FIG. 14D. A Final Prosthetics Solution may include a final abutment, final frame and final bridge/crown.

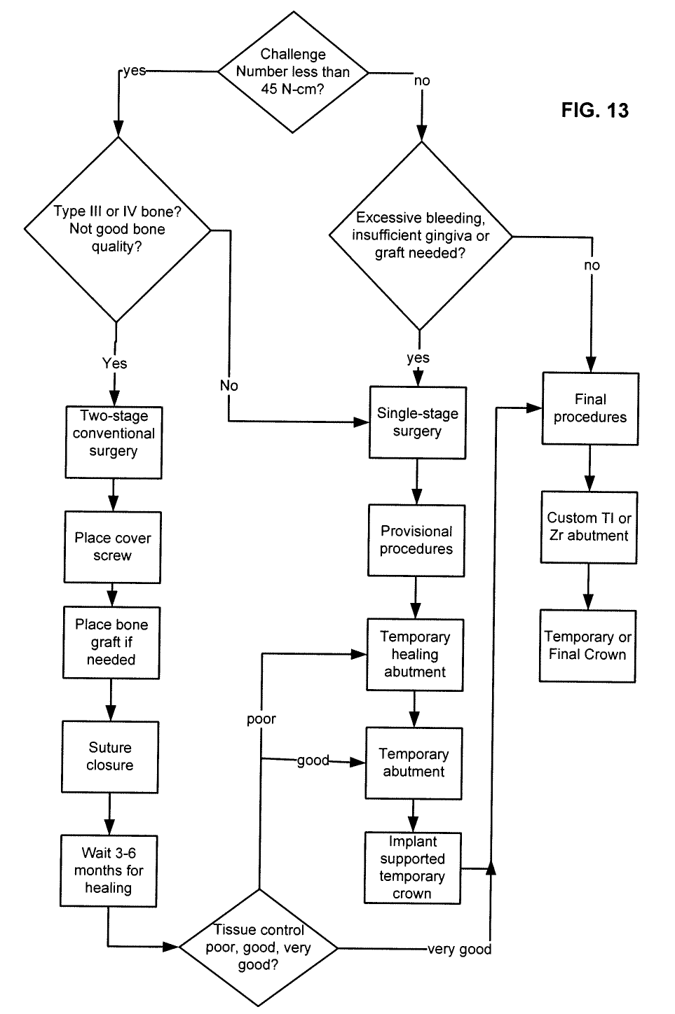

The surgical kit or guide may incorporate a decision tree for communicating the appliances and related information needed during the course of treatment depending on how a patient responds to initial treatment. Thus, for example during surgery should a doctor choose an immediate loading over a delayed loading procedure, the doctor may communicate the decision to the network service, which would then require an order or procurement of the necessary appliances, or the doctor may order the needed appliance directly from a manufacturer based on appliance information included in the kit, e.g., dimensions, material, etc. In another embodiment, the doctor may simply choose among different portions of the kit depending on the decision reached during mid-treatment. For example, the doctor may be provided with different packaged kits coded based on intermediate treatment decisions. FIG. 13 presents an example of a decision tree encountered during surgery. The first decision made is whether to allow for a delayed loading of the fixture or immediate loading depending on the so-called challenge number, as is known in the art. If the torque needed to install the implant is too low, e.g., below 45 N-cm, then a delayed loading becomes necessary because bone growth is needed to support the fixture. Typically this happens when Type II or IV bones are present, or a bone graft is needed. Thus, after installing the fixture, a healing abutment is used.

If the torque level is above 45 N-cm or the bone quality is good (despite a low challenge number), then a single-stage surgery can be used. If a high challenge number is found, and there is not excessive bleeding, then the doctor may choose to conduct the final procedure immediately. Similarly, if two-stage surgery is selected and following the 3-6 month healing period; based on the tissue control quality whether it is poor, good or very good, there are three possible routes to be taken, as shown in FIG. 13.

A decision tree like that depicted in FIG. 13 may be imprinted on top of the delivery kit, with the boxes shown in the flow diagram being containers having peel-off covers. The doctor may then peel off the appropriate box to access the appliance based on the progress of the treatment. By adopting this construction of the kit, the doctor (or his/her assistants) will both be guided to the location of the necessary appliance and informed of the situations when an appliance is used.

Referring to the example in FIG. 13, a kit box or package may include this flow diagram as a guide to performing the treatment, with the process boxes corresponding to cavities or separately packaged boxes corresponding to the appliances used to perform the steps, e.g., a cover screw would be contained within the box or cavity, and covered with a peel-off label that read “place cover screw”. The branches outlined in the flow diagram may, alternatively, be identified by color coding scheme. For instance, if the challenge number was less than 45 N-cm and the bone quality is not good, then the instructions might indicate to use the red colored box. Within the red box one shade of red might be used to distinguish the initial flow up to the 3-6 month waiting period, with the three branches from the decision point based on tissue control, i.e., poor, good, very good being a maroon, purple or dark red, for example. In other embodiments, colors may be replaced by icons or symbols, letters or numbers.

While particular embodiments of the present invention have been shown and described, it will be obvious to those skilled in the art that changes and modifications can be made without departing from this invention in its broader aspects. Therefore, the appended claims are to encompass within their scope all such changes and modifications as they fall within the true spirit and scope of this invention.

What is claimed is:

1. A method for arranging dental implant treatments relating to dental implant appliances over a network, comprising:
providing a server which is configured to provide information relating to a manufacture of appliances for a dental kit, the server being in communication with a database having manufacturing information;
accessing via the server manufacturing information in the database including inquiring about the status of manufacture of one or more appliances of the dental kit;
automatically transmitting to a desired computer information relating to the status of manufacture of the one or more kit appliances prior to completion of the kit;
scheduling a patient appointment when the kit has reached a predefined manufacturing stage, the patient appointment occurring prior to completion of the kit; and
delivering at least a portion of a patient kit including patient-specific implant appliances and patient-specific practice model.

2. The method of claim 1, wherein the server sends a message to a computer when the appliances reach one or more manufacturing stages, including an estimate of the arrival time.

3. The method of claim 1, wherein the server receives a message from a computer when an appliance needs to be manufactured, and the server responds with a message including an estimated arrival time.

4. The method of claim 1, wherein the server and computer send messages over the network conveying information relating to the manufacturing progress.

5. The method of claim 1, wherein the server maintains an on-line timeline to show progress of manufacturing and treatment.

6 A system for supporting dental patient scheduling and treatment processes relating to a dental appliance kit, comprising:
a server configured to transmit via a network information relating to the manufacturing progress of one or more dental appliances, and a device connected to the network by one or more nodes;
a database storing information regarding a manufacturing progress of one or more dental appliances requested from the device, the database being configured for reporting updates to the manufacturing progress including indicating whether manufacturing has reached a predetermined stage, and the server being further configured to transmit, automatically, manufacturing progress information to the patient or a treatment professional in the absence of prompting the server to communicate the manufacturing progress information, the transmission being initiated prior to completion of all manufacturing operations for each of the appliances of the kit;
wherein the server is configured to schedule a patient visit with a dental professional based on the manufacturing progress information, and this patient scheduling occurring prior to completion of all manufacturing operations for each of the appliances; and
at least a portion of a patient kit including manufactured, patient-specific implant appliances and a patient-specific practice model.

7. The system of claim 6, wherein the server is configured to send a message to the device when the appliances reach one or more manufacturing stages, including an estimate of the arrival time.

8. The system of claim 6, wherein the server is configured to receive a message from the device when an appliance needs to be manufactured, and the server is configured to respond with a message including an estimated arrival time.

9. The system of claim 6, wherein the server is configured to maintain an on-line timeline to show a progress of a manufacturing process and treatment.

10. A dental patient's implant kit, comprising:
instructions for treating the patient; and
a portion containing at least a first and second appliance adapted for use in carrying out a restoration of a patient's dentition, the first and second appliances being specifically chosen for the patient's condition and logically arranged within the kit according to the function of the first and second appliance in treating the patient's condition;
wherein the kit is configured for being delivered to a dental professional.

11. A kit as in claim 10, the portion comprising a practice portion and a final portion specifically chosen for the patient's condition, the practice portion adapted for allowing a dental professional to practice an implant procedure using appliances specifically chosen for the patient, and the final portion including a plurality of appliances specifically chosen for installing the implant and prosthetics in the patient's mouth.

12. A kit as in claim 10, wherein the portion is at least one of a practice model portion, surgical components portion, provisional prosthetics solution portion, or final prosthetics solution portion.

13. A kit as in claim 10, wherein the portion includes a fixture and an abutment or crown.

14. A kit as in claim 10, wherein the instructions include each one of a plurality of indicia associated with one or more of respective appliances specifically chosen for the patient's condition, the indicia indicating a sequence of use for the appliances, or condition precedent for its use.

15. A kit as in claim 14, wherein the indicia is at least one of a plurality of colors, symbols, tags, letters, patterns or a flow diagram.

16. A kit as in claim 10, wherein the instructions include a plurality of sealed compartments each having one or more appliances chosen for the patient's condition and arranged in a logical fashion according to a method of use.

17. A kit as in claim 16, wherein the compartments are related to each other by a displayed flow diagram having the compartments representing actions to be taken based on a decision point in the flow diagram.

18. A kit as in claim 17, the kit further including a locking system configured for rendering the second appliance inoperable until after, or if the first appliance has been selected for use.

19. A kit as in claim 18, the displayed flow diagram including a first path of treatment including steps A, B then C, wherein step B is intended to be performed before step C, and a second, alternative path of treatment including steps A, D and E, wherein step D is intended to be performed before step E,
wherein the first appliance is associated with step B and the second appliance is associated with step C; and
wherein the second appliance is rendered inoperable when the second path of treatment is selected or until the first appliance is selected for use.

20. A kit as in claim 18, the displayed flow diagram including a first path of treatment including steps A, B then C, wherein step B is intended to be performed before step C, and a second, alternative path of treatment including steps A, D and E, wherein step D is intended to be performed before step E,
wherein the first appliance is associated with step B and the second appliance is associated with step D; and
wherein the second appliance is rendered inoperable if the first path of treatment is selected or the first appliance is selected for use.

21. A kit as in claim 17, the kit further including a tracking device in communication with the components and adapted for recording and/or transmitting a signal when a compartment has been opened.

22. A kit as in claim 10, wherein the instructions include a non-text portion configured as a means for providing a plurality of appliances in a sequence corresponding to a logical order for treating the patient's condition.

23. A method for fabricating a complete set of dental implant components, said method comprising:
providing an initial digital data set representing an initial missing tooth arrangement;
providing a second digital data set representing a reverse engineered missing tooth arrangement;
designing a digital set of dental implant components based on the second digital data set; and
producing a set of dental implant components based on the designed digital set of dental implant components; and
providing the manufactured components in a single kit.
